(19) United States
(12) Patent Application Publication
(10) Pub. No.: US 2026/0027820 A1
(43) Pub. Date: Jan. 29, 2026

(54) Drive Signal Output Circuit And Liquid Ejecting Apparatus

(71) Applicant: SEIKO EPSON CORPORATION, Tokyo (JP)

(72) Inventors: Noritaka IDE, Shiojiri (JP); Yoichiro KONDO, Chino (JP); Dai NOZAWA, Matsumoto (JP); Kunio TABATA, Shiojiri (JP); Rika TANIMOTO, Matsumoto (JP); Satoru UEMATSU, Shiojiri (JP)

(21) Appl. No.: 19/276,408

(22) Filed: Jul. 22, 2025

(30) Foreign Application Priority Data
Jul. 23, 2024 (JP) 2024-117941

(51) Int. Cl. B41J 2/045

(52) U.S. Cl. CPC B41J 2/04541; B41J 2/0455; B41J 2/0459; B41J 2/04581

(57) ABSTRACT

A drive signal output circuit outputs a drive signal for driving a capacitive load and includes: a modulation circuit that modulates a base drive signal on which the drive signal is based, and outputs the modulated base drive signal as a modulated signal, an amplifier circuit that amplifies the modulated signal and outputs the amplified modulated signal, and a demodulation circuit that demodulates the amplified modulated signal and outputs the demodulated signal as the drive signal. The demodulation circuit includes an inductive circuit, a capacitive circuit, and a switch circuit. The amplified modulated signal is input to a first end of the inductive circuit. A second end of the inductive circuit is electrically coupled to a first end of the capacitive circuit. The switch circuit switches an inductance value of the inductive circuit between a first inductance value and a second inductance value different from the first inductance value.

The present application is based on, and claims priority from JP Application Serial Number 2024-117941, filed Jul. 23, 2024, the disclosure of which is hereby incorporated by reference herein in its entirety.

### BACKGROUND

### 1. Technical Field

The present disclosure relates to a drive signal output circuit and a liquid ejecting apparatus.

### 2. Related Art

As a liquid ejecting apparatus that forms an image or a document on a medium by ejecting liquid, an apparatus using a piezoelectric element is known. In such a liquid ejecting apparatus, piezoelectric elements are provided corresponding to respective nozzles from which liquid is ejected, and each of the piezoelectric elements is driven based on a drive signal. When the piezoelectric elements are driven, liquid is ejected from the nozzles provided corresponding to the piezoelectric elements. In order to operate the piezoelectric elements, it is necessary to supply a sufficient current. Therefore, a drive circuit that outputs a drive signal for driving the piezoelectric elements includes an amplifier circuit that amplifies a base drive signal on which the drive signal is based.

For example, JP-A-2022-117050 discloses a liquid ejecting apparatus including a drive circuit that outputs a drive signal for driving a piezoelectric element and includes a digital amplifier circuit.

However, the technique described in JP-A-2022-117050 is not sufficient from the viewpoint of achieving a high frequency of the drive signal.

### SUMMARY

According to an aspect of the present disclosure, a drive signal output circuit that outputs a drive signal for driving a capacitive load includes: a modulation circuit that modulates a base drive signal on which the drive signal is based, and outputs the modulated base drive signal as a modulated signal; an amplifier circuit that amplifies the modulated signal and outputs the amplified modulated signal; and a demodulation circuit that demodulates the amplified modulated signal and outputs the demodulated signal as the drive signal. The demodulation circuit includes an inductive circuit, a capacitive circuit, and a switch circuit. The amplified modulated signal is input to a first end of the inductive circuit, and a second end of the inductive circuit is electrically coupled to a first end of the capacitive circuit. The demodulation circuit outputs the drive signal from a coupling point where the second end of the inductive circuit and the first end of the capacitive circuit are electrically coupled. The switch circuit switches an inductance value of the inductive circuit between a first inductance value and a second inductance value different from the first inductance value.

According to an aspect of the present disclosure, a liquid ejecting apparatus includes: an ejection section that ejects liquid by driving a capacitive load; and a drive signal output circuit that outputs a drive signal for driving the capacitive load. The drive signal output circuit includes a modulation circuit that modulates a base drive signal on which the drive signal is based, and outputs the modulated base drive signal as a modulated signal, an amplifier circuit that amplifies the modulated signal and outputs the amplified modulated signal, and a demodulation circuit that demodulates the amplified modulated signal and outputs the demodulated signal as the drive signal. The demodulation circuit includes an inductive circuit, a capacitive circuit, and a switch circuit. The amplified modulated signal is input to a first end of the inductive circuit, and a second end of the inductive circuit is electrically coupled to a first end of the capacitive circuit. The demodulation circuit outputs the drive signal from a coupling point where the second end of the inductive circuit and the first end of the capacitive circuit are electrically coupled. The switch circuit switches an inductance value of the inductive circuit between a first inductance value and a second inductance value different from the first inductance value.

### BRIEF DESCRIPTION OF THE DRAWINGS

FIG. 1 is a diagram illustrating an example of a schematic configuration of a liquid ejecting apparatus.

FIG. 2 is a diagram illustrating an example of a functional configuration of the liquid ejecting apparatus.

FIG. 3 is a diagram illustrating a schematic structure of one of a plurality of ejection sections included in ejection heads.

FIG. 4 is a diagram illustrating an example of a signal waveform of a drive signal.

FIG. 5 is a diagram illustrating an example of a configuration of a selection control circuit and a plurality of selection circuits.

FIG. 6 is a diagram illustrating an example of the content of decoding by decoders.

FIG. 7 is a diagram illustrating an example of a configuration of each of the selection circuits.

FIG. 8 is a diagram illustrating a configuration of a drive signal output circuit.

FIG. 9 is a diagram illustrating an example of a configuration of a demodulation circuit included in the drive signal output circuit.

FIG. 10 is a diagram for explaining an operation of the demodulation circuit.

FIG. 11 is a diagram illustrating an example of a method of controlling the liquid ejecting apparatus including the drive signal output circuit.

FIG. 12 is a diagram illustrating a specific example of a drive signal output process.

FIG. 13 is a diagram illustrating a specific example of a demodulation process.

FIG. 14 is a diagram illustrating an example of a configuration of a demodulation circuit according to a first modification.

FIG. 15 is a diagram illustrating an example of a configuration of a demodulation circuit according to a second modification.

FIG. 16 is a diagram illustrating a configuration of a drive signal output circuit according to a second embodiment.

FIG. 17 is a diagram illustrating an example of a configuration of a demodulation circuit according to the second embodiment.

FIG. 18 is a diagram for explaining an example of an operation of the demodulation circuit according to the second embodiment.

FIG. 19 is a diagram illustrating a specific example of a demodulation process according to the second embodiment.

FIG. 20 is a diagram illustrating a configuration of a drive signal output circuit according to a third embodiment.

FIG. 21 is a diagram illustrating an example of a configuration of a demodulation circuit according to the third embodiment.

FIG. 22 is a diagram illustrating a specific example of a demodulation process according to the third embodiment.

### DESCRIPTION OF EMBODIMENTS

Hereinafter, preferred embodiments of the present disclosure will be described with reference to the drawings. The drawings to be used are for convenience of description. The embodiments described below do not unduly limit the contents described in the appended claims. In addition, all of configurations described below are not necessarily essential components of the present disclosure.

### 1. First Embodiment

### 1.1. Configuration of Liquid Ejecting Apparatus

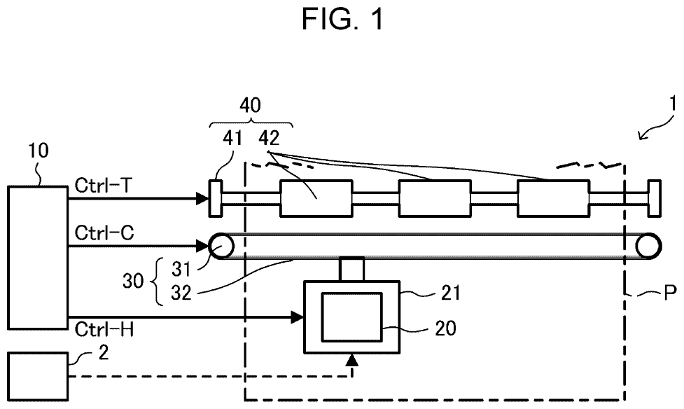

FIG. 1 is a diagram illustrating an example of a schematic configuration of a liquid ejecting apparatus 1. The liquid ejecting apparatus 1 according to a first embodiment is a serial printing type ink jet printer in which a carriage 21 on which a head unit 20 that ejects ink as an example of liquid is mounted reciprocates along a scanning axis and the head unit 20 ejects ink onto a medium P transported along a transport direction so as to form a desired image on the medium P. As the medium P that is used in the liquid ejecting apparatus 1, an arbitrary printing target such as printing paper, a resin film, or fabric can be used. The liquid ejecting apparatus 1 is not limited to a serial printing type ink jet printer, and may be a line printing type ink jet printer. In addition, the liquid ejecting apparatus 1 is not limited to an ink jet printer, and may be a color material ejecting apparatus that is used for manufacturing a color filter of a liquid crystal display or the like, an electrode material ejecting apparatus that is used for forming an electrode of an organic EL display, a field emission display (FED), or the like, a bioorganic material ejecting apparatus that is used for manufacturing a biochip, a three-dimensional shaping apparatus, a textile printing apparatus, or the like.

As illustrated in FIG. 1, the liquid ejecting apparatus 1 includes an ink container 2, a control unit 10, a head unit 20, a moving unit 30, and a transport unit 40.

In the ink container 2, a plurality of types of ink to be ejected onto the medium P are stored. Examples of the color of the ink stored in the ink container 2 include black, cyan, magenta, yellow, red, and gray. As the ink container 2 in which the ink is stored, an ink cartridge, a bag-shaped ink pack formed of a flexible film, an ink tank which can be replenished with ink, or the like can be used.

The control unit 10 includes, for example, a processing circuit such as a central processing unit (CPU) or a field programmable gate array (FPGA) and a storage circuit such as a semiconductor memory, and controls each of components of the liquid ejecting apparatus 1 including the head unit 20.

The head unit 20 is mounted on the carriage 21. The carriage 21 is fixed to an endless belt 32 included in the moving unit 30. In addition to the head unit 20, the ink container 2 may be mounted on the carriage 21.

A control signal Ctrl-H for controlling the head unit 20 is output by the control unit 10 and input to the head unit 20 mounted on the carriage 21. The ink stored in the ink container 2 is supplied to the head unit 20 through a tube (not illustrated). The head unit 20 ejects, based on the input control signal Ctrl-H, the ink supplied from the ink container 2.

The moving unit 30 includes a carriage motor 31 and the endless belt 32. The carriage motor 31 is driven based on a control signal Ctrl-C input from the control unit 10. The endless belt 32 rotates in accordance with the driving of the carriage motor 31. Accordingly, the carriage 21 fixed to the endless belt 32 reciprocates along the scanning axis. That is, the head unit 20 mounted on the carriage 21 reciprocates along the scanning axis intersecting the transport direction in which the medium P is transported.

The transport unit 40 includes a transport motor 41 and a transport roller 42. The transport motor 41 is driven based on a control signal Ctrl-T input from the control unit 10. The transport roller 42 rotates in accordance with the driving of the transport motor 41. As the transport roller 42 rotates, the medium P is transported in the transport direction.

In the liquid ejecting apparatus 1 configured as described above, the head unit 20 mounted on the carriage 21 ejects the ink onto the medium P in conjunction with the transport of the medium P by the transport unit 40 and the reciprocating movement of the carriage 21 by the moving unit 30. Accordingly, the ink ejected from the head unit 20 lands on an arbitrary position on a surface of the medium P. As a result, a desired image is formed on the medium P.

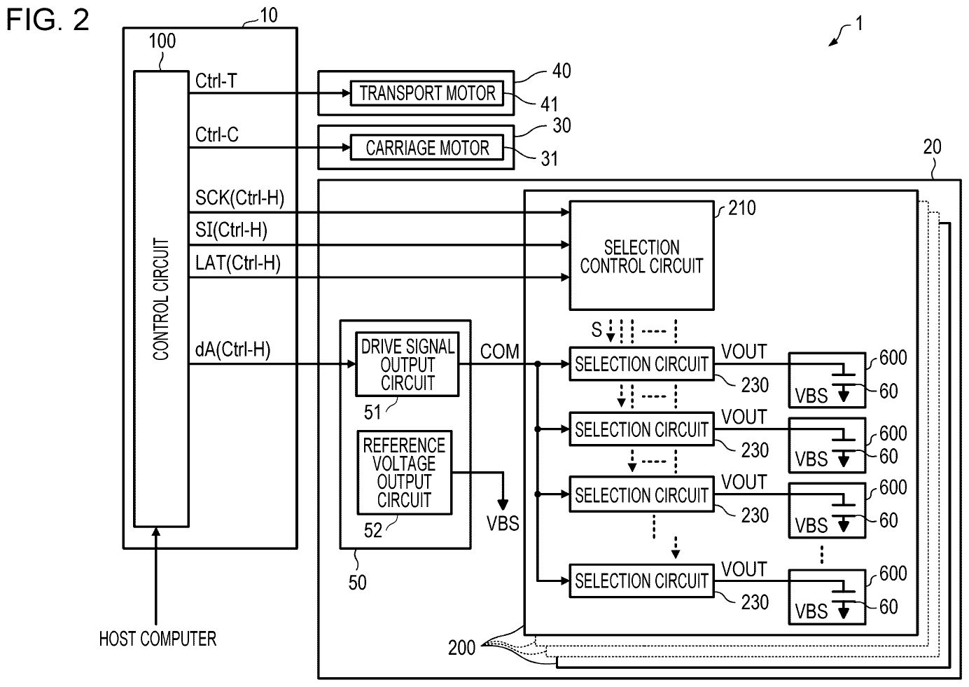

A specific example of a functional configuration of the liquid ejecting apparatus 1 configured as described above will be described. FIG. 2 is a diagram illustrating the example of the functional configuration of the liquid ejecting apparatus 1. As illustrated in FIG. 2, the liquid ejecting apparatus 1 includes the control unit 10, the head unit 20, the moving unit 30, and the transport unit 40.

The control unit 10 includes a control circuit 100.

When an image signal is input to the control circuit 100 from an external apparatus such as a host computer, the control circuit 100 generates various control signals based on the image signal and outputs the control signals to corresponding components.

Specifically, when the image signal is input to the control circuit 100 and processing of printing on the medium P is performed, the control circuit 100 generates the control signal Ctrl-T and the control signal Ctrl-C. The control signal Ctrl-T output by the control circuit 100 is input to the transport motor 41 included in the transport unit 40. The transport motor 41 is driven based on the control signal Ctrl-T. The medium P is transported along the transport direction by a driving force of the transport motor 41. In addition, the control signal Ctrl-C output by the control circuit 100 is input to the carriage motor 31 included in the moving unit 30. The carriage motor 31 is driven based on the control signal Ctrl-C. The carriage 21 on which the head unit 20 is mounted reciprocates along the scanning axis by a driving force of the carriage motor 31. The transport unit 40 may include one or a plurality of transport rotors in addition to the transport motor 41. In addition, the transport unit 40 may include a transport motor driver circuit that converts the control signal Ctrl-T into a predetermined signal for driving the transport motor 41. Further, the moving unit 30 may include a carriage motor driver circuit that converts the control signal Ctrl-C into a predetermined signal for driving the carriage motor 31.

In addition, the control circuit 100 generates, based on the image signal input from the external apparatus, a clock signal SCK, a print data signal SI, a latch signal LAT, and a base drive signal dA as control signals Ctrl-H, and outputs the clock signal SCK, the print data signal SI, the latch signal LAT, and the base drive signal dA to the head unit 20.

The head unit 20 includes a drive circuit 50 and a plurality of ejection heads 200.

The drive circuit 50 includes a drive signal output circuit 51. A digital base drive signal dA as a control signal Ctrl-H is input to the drive signal output circuit 51. The drive signal output circuit 51 generates a drive signal COM by converting the input drive signal dA from a digital signal to an analog signal and performing class D amplification on the converted analog signal, and outputs the generated drive signal COM. The drive signal COM output by the drive signal output circuit 51 is input to the ejection heads 200. That is, the base drive signal dA is a signal on which the drive signal COM is based, and defines a waveform of the drive signal COM. It suffices for the base drive signal dA to be a signal defining the waveform of the drive signal COM, and the base drive signal dA may be an analog signal.

The drive circuit 50 also includes a reference voltage output circuit 52. The reference voltage output circuit 52 generates a reference voltage signal VBS with a constant direct-current voltage of 5.5 V, 6 V, or the like, and outputs the reference voltage signal VBS to the ejection heads 200. The reference voltage signal VBS functions as a reference electrical potential for driving piezoelectric elements 60 (described later) included in the ejection heads 200. The electrical potential of the reference voltage signal VBS is not limited to 5.5 V, 6 V, or the like and may be a ground electrical potential.

Each of the ejection heads 200 includes a selection control circuit 210, a plurality of selection circuits 230, and a plurality of ejection sections 600. The ejection sections 600 are provided corresponding to the respective selection circuits 230.

The clock signal SCK, the print data signal SI, and the latch signal LAT are input to the selection control circuit 210. The selection control circuit 210 generates selection signals S corresponding to the respective selection circuits 230 based on the input clock signal SCK, the input print data signal SI, and the input latch signal LAT, and outputs the selection signals S to the corresponding selection circuits 230.

The drive signal COM is input to the selection circuits 230, and the selection signals S output by the selection control circuit 210 are input to the corresponding selection circuits 230. Each of the selection circuits 230 generates a drive signal VOUT by selecting or not selecting the drive signal COM based on the selection signal S input to the selection circuit 230, and supplies the generated drive signal VOUT to the ejection section 600 corresponding to the selection circuit 230. That is, each of the selection circuits 230 switches whether to supply the drive signal COM as a drive signal VOUT to the ejection section 600 corresponding to the selection circuit 230.

Each of the plurality of ejection sections 600 includes a piezoelectric element 60. The drive signal VOUT output by each of the selection circuits 230 is supplied to a first end of the piezoelectric element 60 included in the ejection section 600 corresponding to the selection circuit 230. In addition, the reference voltage signal VBS output by the reference voltage output circuit 52 is commonly supplied to a second end of the piezoelectric element 60 included in each of the plurality of ejection sections 600. Each of the piezoelectric elements 60 is driven based on the difference in electrical potential between the drive signal VOUT supplied to the first end of the piezoelectric element 60 and the reference voltage signal VBS supplied to the second end of the piezoelectric element 60. Ink in amounts based on the driving of the piezoelectric elements 60 are ejected from the ejection sections 600.

### 1.2. Configuration of Each Ejection Head

### 1.2.1. Structure of Each Ejection Section

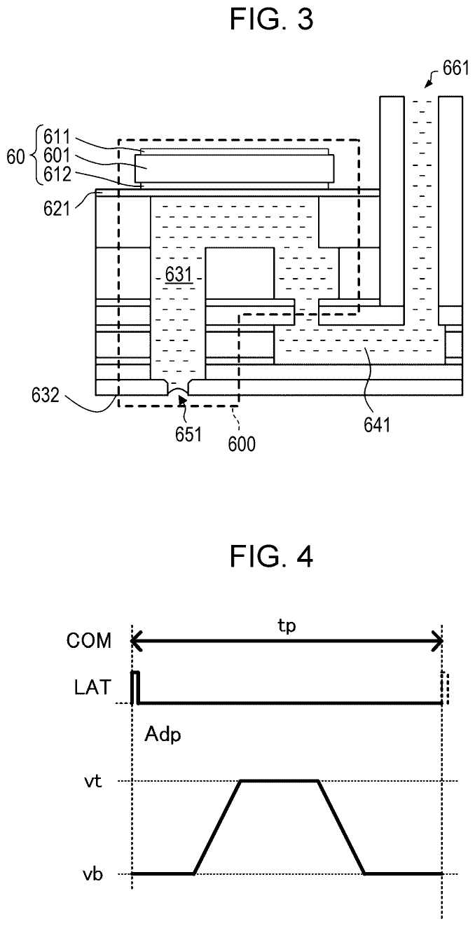

An example of a structure of each of the ejection sections 600 included in the ejection heads 200 will be described. FIG. 3 is a diagram illustrating a schematic structure of one of the plurality of ejection sections 600 included in the ejection heads 200. As illustrated in FIG. 3, each of the ejection sections 600 includes a piezoelectric element 60, a vibration plate 621, a cavity 631, and a nozzle 651.

The cavity 631 is filled with ink supplied from a reservoir 641. The ink is introduced into the reservoir 641 from the ink container 2 through an ink tube (not illustrated) and a supply port 661. That is, the cavity 631 is filled with the ink stored in the corresponding ink container 2.

The vibration plate 621 is deformed by driving of the piezoelectric element 60 disposed on a top surface of the vibration plate 621 in FIG. 3. As the vibration plate 621 is deformed, the internal volume of the cavity 631 filled with the ink is increased or decreased. That is, the vibration plate 621 functions as a diaphragm that changes the internal volume of the cavity 631.

The nozzle 651 is an opening disposed in a nozzle plate 632 and communicating with the cavity 631. When the internal volume of the cavity 631 changes, ink in an amount corresponding to the change in the internal volume is ejected from the nozzle 651.

The piezoelectric element 60 has a structure in which a piezoelectric body 601 is disposed between a pair of electrodes 611 and 612. Central portions of the electrodes 611 and 612 between which the piezoelectric body 601 is disposed in the structure are bent in a vertical direction together with the vibration plate 621 based on the difference in electrical potential between signals supplied to the electrodes 611 and 612.

For example, a drive signal VOUT is supplied to one of the electrodes 611 and 612 of the piezoelectric element 60, and the reference voltage signal VBS is supplied to the other of the electrodes 611 and 612 of the piezoelectric element 60. When the voltage value of the drive signal VOUT is increased, the piezoelectric element 60 is bent upward. When the piezoelectric element 60 is bent upward, the vibration plate 621 is deformed and the internal volume of the cavity 631 is increased. As a result, ink is drawn into the cavity 631 from the reservoir 641. On the other hand, when the voltage value of the drive signal VOUT is decreased, the piezoelectric element 60 is bent downward. When the piezoelectric element 60 is bent downward, the vibration plate 621 is deformed and the internal volume of the cavity 631 is decreased. As a result, ink in an amount corresponding to the decrease in the internal volume is ejected from the nozzle 651.

That is, the ejection section 600 includes the piezoelectric element 60 that is driven by the drive signal VOUT based on the drive signal COM, and ejects ink when the piezoelectric element 60 is driven.

The piezoelectric element 60 is not limited to the structure illustrated in FIG. 3, and may have any structure as long as ink can be ejected from the ejection section 600. That is, the piezoelectric element 60 is not limited to the configuration for flexural vibration described above, and may have, for example, a configuration for longitudinal vibration. Further, the piezoelectric element 60 may be bent downward when the voltage value of the drive signal VOUT is increased, and may be bent upward when the voltage value of the drive signal VOUT is decreased.

### 1.2.2. Functional Configuration of Selection Control

### Circuits and Selection Circuits

Next, a functional configuration of the selection control circuit 210 and the plurality of selection circuits 230 included in each of the ejection heads 200 will be described. Before description of the functional configuration of the selection control circuit 210 and the plurality of selection circuits 230, an example of the drive signal COM controlled to be selected or not to be selected by the selection control circuit 210 and the plurality of selection circuits 230 will be described. FIG. 4 is a diagram illustrating an example of a signal waveform of the drive signal COM. As illustrated in FIG. 4, the drive signal COM includes a trapezoidal waveform Adp provided for each period tp from the time when the latch signal LAT rises to the time when the latch signal LAT rises next. The trapezoidal waveform Adp includes a period of time when the voltage value is constant at a voltage vb, a period of time when the voltage value is constant at a voltage vt higher than the voltage vb after the period of time when the voltage value is constant at the voltage vb, and a period of time when the voltage value is constant at the voltage vb after the period of time when the voltage value is constant at the voltage vt. That is, the drive signal COM includes the trapezoidal waveform Adp in which the voltage value changes within a range from the voltage vb to the voltage vt and in which the voltage value starts at the voltage vb and ends at the voltage vb in the period tp.

The value of the voltage vb serves as a reference for the deformation of each of the piezoelectric elements 60. When a voltage of a drive signal VOUT based on the drive signal COM supplied to the piezoelectric element 60 changes from the voltage vb to the voltage vt, the piezoelectric element 60 is driven upward as illustrated in FIG. 3. Accordingly, the vibration plate 621 is deformed upward as illustrated in FIG. 3, and the internal volume of the cavity 631 is increased. As a result, the ink is drawn into the cavity 631 from the reservoir 641. Thereafter, when the voltage of the drive signal COM supplied to the piezoelectric element 60 changes from the voltage vt to the voltage vb, the piezoelectric element 60 is driven downward as illustrated in FIG. 3. Accordingly, the vibration plate 621 is deformed downward as illustrated in FIG. 3, and the internal volume of the cavity 631 is decreased. As a result, the ink stored in the cavity 631 is ejected from the nozzle 651.

The signal waveform of the drive signal COM illustrated in FIG. 4 is an example and is not limited thereto. The drive signal COM may include signal waveforms having various shapes based on physical properties of ink, the temperature of the ink, an amount of the ink to be ejected, a period in which the ink is ejected, the type of the medium P, the transport speed, and the like.

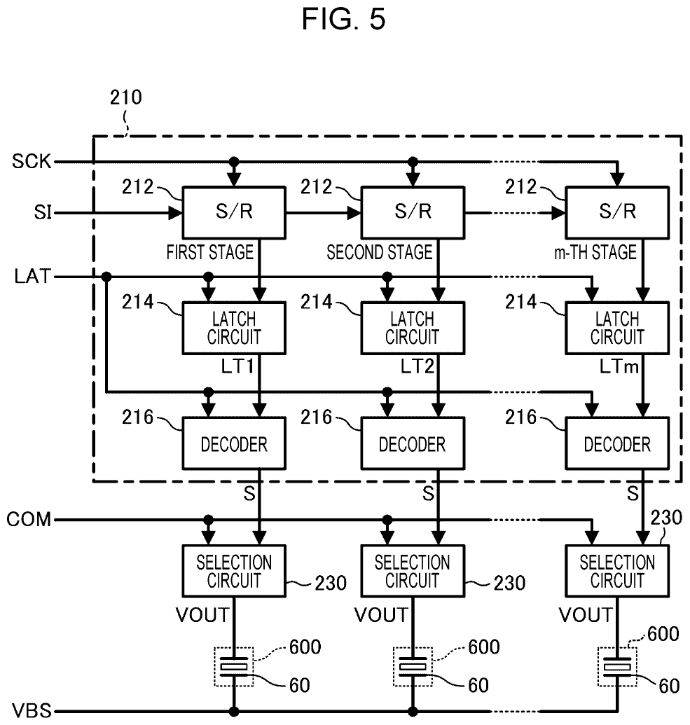

Based on the clock signal SCK, the print data signal SI, and the latch signal LAT, the selection control circuit 210 outputs the selection signals S for switching whether to output the drive signal COM as the drive signals VOUT to the respective selection circuits 230 in the period tp. Then, the plurality of selection circuits 230 switch whether to output the drive signal COM as the drive signals VOUT based on the input selection signals S. Accordingly, the ejection of the ink from the nozzles 651 in the period tp is controlled. FIG. 5 is a diagram illustrating an example of a configuration of the selection control circuit 210 and the plurality of selection circuits 230. In the following description, it is assumed that each of the ejection heads 200 includes m ejection sections 600.

The clock signal SCK, the print data signal SI, and the latch signal LAT are input to the selection control circuit 210. In addition, the selection control circuit 210 includes a set of a shift register (S/R) 212, a latch circuit 214, and a decoder 216 for each of the m ejection sections 600. That is, the selection control circuit 210 includes m shift registers 212, m latch circuits 214, and m decoders 216.

The print data signal SI is input to the selection control circuit 210 in synchronization with the clock signal SCK. In addition, the print data signal SI serially includes 1-bit print data pieces [SId] corresponding to the respective m ejection sections 600 and provided for selecting whether to eject ink. The print data pieces [SId] included in the print data signal SI are held in the m shift registers 212 corresponding to the m ejection sections 600. Specifically, the m shift registers 212 corresponding to the piezoelectric elements 60 are cascaded to each other, and the print data signal SI input in serial is sequentially transferred to the shift registers 212 at the subsequent stages in accordance with the clock signal SCK. Then, when the print data pieces [SId] are held in the corresponding shift registers 212, the clock signal SCK is stopped. Accordingly, the print data pieces [SId] included in the print data signal SI are held in the corresponding shift registers 212. In FIG. 5, in order to distinguish the m shift registers 212 from each other, the first stage, the second stage, . . . , and the m-th stage are illustrated in order from the upstream side on which the print data signal SI is input.

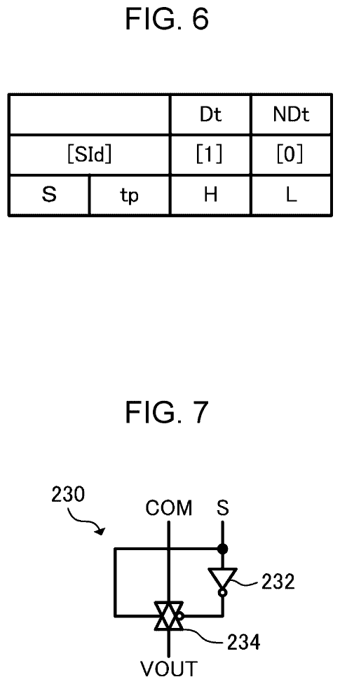

The m latch circuits 214 simultaneously latch the print data pieces [SId] held in the corresponding shift registers 212 at a rising edge of the latch signal LAT. Then, the print data pieces [SId] latched by the latch circuits 214 are input to the corresponding decoders 216. FIG. 6 is a diagram illustrating an example of the content of decoding by the decoders 216. In the period tp, the decoders 216 generate signals of logic levels defined by the input print data pieces [SId], level-shift the signals to a high amplitude logic, and then output the signals as the selection signals S. Specifically, when a print data piece [SId]=[1] is input to each of the decoders 216, the decoder 216 determines that dot formation Dt in which a dot is formed on the medium P has been selected, and outputs an H-level selection signal S. In addition, when a print data piece [SId]=[0] is input to each of the decoders 216, the decoder 216 determines that dot non-formation NDt in which a dot is not formed on the medium P has been selected, and outputs an L-level selection signal S. The selection signals S output by the decoders 216 are output from the selection control circuit 210.

The selection signals S output by the selection control circuit 210 are input to the selection circuits 230. The selection circuits 230 are provided corresponding to the respective m ejection sections 600. That is, each of the ejection heads 200 includes the same number m of selection circuits 230 as the number m of ejection sections 600. FIG. 7 is a diagram illustrating an example of a configuration of each of the selection circuits 230. As illustrated in FIG. 7, each of the selection circuits 230 includes an inverter 232 that is a NOT circuit, and a transmission gate 234.

A selection signal S is input to a positive control terminal in the transmission gate 234. The positive control terminal is not marked with a circle in FIG. 7. The selection signal S is also input to a negative control terminal in the transmission gate 234 after the logic level of the selection signal S is inverted by the inverter 232. The negative control terminal is marked with a circle in FIG. 7. The drive signal COM is supplied to an input terminal of the transmission gate 234. The transmission gate 234 is set to be conductive between the input terminal and an output terminal of the transmission gate 234 when an H-level selection signal S is input to the transmission gate 234. The transmission gate 234 is set to be non-conductive between the input terminal and the output terminal of the transmission gate 234 when an L-level selection signal S is input to the transmission gate 234. That is, the transmission gate 234 outputs the drive signal COM from the output terminal when the logic level of the selection signal S is an H level, and does not output the drive signal COM from the output terminal when the logic level of the selection signal S is an L level. The signal output from the output terminal of the transmission gate 234 included in the selection circuit 230 is supplied to the piezoelectric element 60 of the corresponding ejection section 600 as a drive signal VOUT.

### 1.3. Configuration of Drive Signal Output Circuit

### 1.3.1. Configuration of Drive Signal Output Circuit

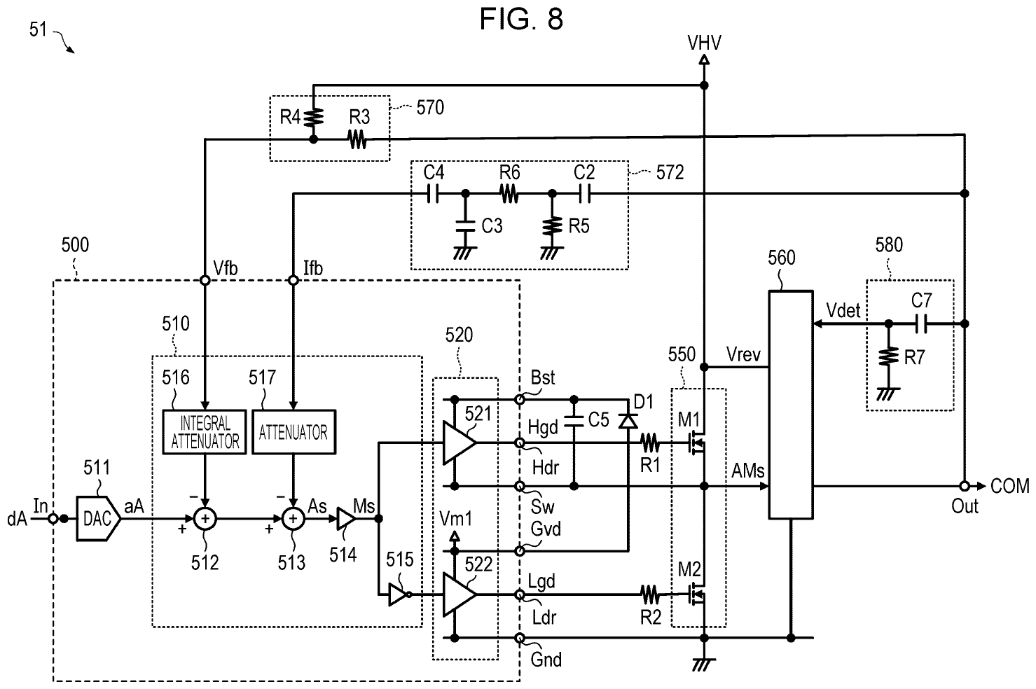

Next, a configuration and operation of the drive signal output circuit 51 included in the drive circuit 50 will be described. FIG. 8 is a diagram illustrating the configuration of the drive signal output circuit 51. As illustrated in FIG. 8, the drive signal output circuit 51 includes an integrated circuit 500, an amplifier circuit 550, a demodulation circuit 560, feedback circuits 570 and 572, a differentiating circuit 580, and a plurality of other circuit elements. The integrated circuit 500 generates a gate signal Hgd and a gate signal Lgd based on the base drive signal dA on which the drive signal COM is based, and outputs the gate signal Hgd and the gate signal Lgd to the amplifier circuit 550. The amplifier circuit 550 includes transistors M1 and M2. When the transistors M1 and M2 are driven based on the gate signals Hgd and Lgd, respectively, the amplifier circuit 550 generates an amplified modulated signal AMs and outputs the amplified modulated signal AMs to the demodulation circuit 560. The demodulation circuit 560 demodulates the amplified modulated signal AMs by smoothing the amplified modulated signal AMs. The signal demodulated by the demodulation circuit 560 is output from the drive signal output circuit 51 as the drive signal COM.

The integrated circuit 500 includes a plurality of terminals including a terminal In, a terminal Bst, a terminal Hdr, a terminal Sw, a terminal Gvd, a terminal Ldr, a terminal Gnd, a terminal Ifb, and a terminal Vfb. The integrated circuit 500 is electrically coupled to external circuits via the plurality of terminals. The integrated circuit 500 includes a digital-to-analog converter (DAC) 511, a modulation circuit 510, and a gate drive circuit 520.

The DAC 511 converts the base drive signal dA that is a digital signal defining the signal waveform of the drive signal COM into the base drive signal aA that is an analog signal. The DAC 511 outputs the base drive signal aA to the modulation circuit 510. A signal obtained by amplifying the base drive signal aA output by the DAC 511 corresponds to the drive signal COM. That is, the base drive signal aA is a target signal before the amplification of the drive signal COM, and the base drive signal dA is a target signal before the amplification of the drive signal COM and defines the shape of the signal waveform of the drive signal COM. The voltage amplitude of the base drive signal aA to be output by DAC 511 is set to be, for example, in a range from 1 V to 2 V.

The modulation circuit 510 generates a modulated signal Ms by modulating the base drive signal aA, and outputs the modulated signal Ms to the gate drive circuit 520. The modulation circuit 510 includes adders 512 and 513, a comparator 514, an inverter 515, an integral attenuator 516, and an attenuator 517.

The integral attenuator 516 attenuates and integrates the voltage value of the drive signal COM input through the terminal Vfb, and outputs the integrated signal to a negative input terminal of the adder 512. The base drive signal aA is input to a positive input terminal of the adder 512. The adder 512 generates a signal having a voltage value obtained by subtracting the voltage value of the signal input to the negative input terminal of the adder 512 from the voltage value of the signal input to the positive input terminal of the adder 512 and integrating the result of the subtraction, and outputs the generated signal to a positive input terminal of the adder 513. While the maximum value of the voltage amplitude of the base drive signal aA is about 2 V as described above, the maximum voltage value of the drive signal COM may exceed 40 V. The integral attenuator 516 attenuates the drive signal COM input through the terminal Vfb in order to match the range of the voltage amplitude of the base drive signal aA and the range of the voltage amplitude of the drive signal COM for calculation of a deviation.

The attenuator 517 supplies a voltage obtained by attenuating a high-frequency component of the drive signal COM input through the terminal Ifb to a negative input terminal of the adder 513. The signal output by the adder 512 is input to the positive input terminal of the adder 513. The adder 513 generates a voltage signal As by subtracting the voltage value of the signal input to the negative input terminal of the adder 513 from the voltage value of the signal input to the positive input terminal of the adder 513 and outputs the voltage signal As to the comparator 514. The voltage signal As is obtained by subtracting the voltage value of the signal supplied to the terminal Vfb from the voltage value of the base drive signal aA and further subtracting the voltage value of the signal supplied to the terminal Ifb from the result of the subtraction. Therefore, the voltage signal As is obtained by correcting the deviation obtained by subtracting the attenuated voltage of the drive signal COM from the voltage value of the base drive signal aA as a target with the high-frequency component of the drive signal COM.

The comparator 514 performs pulse modulation on the voltage signal As and outputs the voltage signal As as the modulated signal Ms. Specifically, the comparator 514 outputs the modulated signal Ms that is set to an H level when the voltage value of the voltage signal As is set to be greater than or equal to a predetermined threshold Vth1 in a period of time when the voltage value of the voltage signal As increases, and is set to an L level when the voltage value of the voltage signal As is set to be less than a predetermined threshold Vth2 in a period of time when the voltage value of the voltage signal As decreases. The thresholds Vth1 and Vth2 are set such that the threshold Vth1 is greater than the threshold Vth2. The frequency and duty ratio of the modulated signal Ms change in accordance with the base drive signal aA obtained by converting the base drive signal dA. That is, by adjusting the modulation gain corresponding to the sensitivity of the attenuator 517, the amounts of change in the frequency and duty ratio of the modulated signal Ms can be adjusted.

The modulated signal Ms is input to a gate driver 521 included in the gate drive circuit 520. In addition, after the logic level of the modulated signal Ms is inverted by the inverter 515, a signal obtained by inverting the logic level of the modulated signal Ms is also input to a gate driver 522 included in the gate drive circuit 520. That is, the signals with logic levels that are mutually exclusive are input to the gate driver 521 and the gate driver 522.

The timing of inputting the signals to the gate drivers 521 and 522 may be controlled so that the logic levels of the signals are not concurrently an H level. That is, the case where the above-described “logic levels are mutually exclusive” indicates that the logic level of the signal input to the gate driver 521 and the logic level of the signal input to the gate driver 522 are not concurrently an H level, and includes a case where the logic level of the signal input to the gate driver 521 and the logic level of the signal input to the gate driver 522 are concurrently an L level.

The gate drive circuit 520 includes the gate driver 521 and the gate driver 522.

The gate driver 521 generates a gate signal Hgd by level-shifting the modulated signal Ms output by the comparator 514, and outputs the gate signal Hgd from the integrated circuit 500 through the terminal Hdr. Of power supply voltages of the gate driver 521, a signal is supplied to the gate driver 521 on the high electrical potential side of the gate driver 521 through the terminal Bst, and a signal is supplied to the gate driver 521 on the low electrical potential side of the gate driver 521 through the terminal Sw. The terminal Bst is electrically coupled to a first end of a capacitor C5 and the cathode of a diode D1. A second end of the capacitor C5 is electrically coupled to the terminal Sw. The anode of the diode D1 is electrically coupled to the terminal Gvd. Further, a voltage signal Vm1 with a direct-current voltage of, for example, 7.5 V generated by a power supply circuit (not illustrated) is supplied to the terminal Gvd. Accordingly, the difference in electrical potential between the terminal Bst and the terminal Sw is the difference in electrical potential between the first end and the second end of the capacitor C5 and is substantially equal to the voltage value of the voltage signal Vm1. Therefore, the gate driver 521 generates, in accordance with the logic level of the input modulated signal Ms, an H-level gate signal Hgd having a voltage value that is greater than the voltage value of the terminal Sw by the voltage value of the voltage signal Vm1 or an L-level gate signal Hgd having a voltage value equal to the voltage value of the terminal Sw, and outputs the generated gate signal Hgd from the terminal Hdr.

The gate driver 522 operates on a lower electrical potential side than the gate driver 521. The gate driver 522 generates a gate signal Lgd by level-shifting the signal obtained by inverting the logic level of the modulated signal Ms output by the comparator 514 by the inverter 515, and outputs the gate signal Lgd from the integrated circuit 500 through the terminal Ldr. Of power supply voltages of the gate driver 522, the voltage signal Vm1 is supplied to the gate driver 522 on the high electrical potential side of the gate driver 522, and the ground electrical potential is supplied to the gate driver 522 on the low electrical potential side of the gate driver 522 through the terminal Gnd. The gate driver 522 generates, in accordance with the logic level of the signal input to the gate driver 522, an H-level gate signal Lgd having a voltage value that is greater than the voltage value of the terminal Gnd by the voltage value of the voltage signal Vm1 or an L-level gate signal Lgd having a voltage value that is equal to the voltage value of the terminal Gnd and is the ground electrical potential, and outputs the generated gate signal Lgd from the terminal Ldr.

As described above, the gate signal Hgd is obtained by level-shifting the voltage value of the modulated signal Ms, and the gate signal Lgd is obtained by inverting the logic level of the modulated signal Ms and then level-shifting the voltage value of the inverted signal. Considering this point, the gate signal Hgd and the gate signal Lgd output by the gate drive circuit 520 can also be regarded as signals obtained by modulating the base drive signal aA obtained by converting the base drive signal dA.

The amplifier circuit 550 includes the pair of transistors M1 and M2 that are N-channel field-effect transistors (FETs).

A voltage signal VHV with, for example, a direct-current voltage of 42 V is supplied to the drain terminal of the transistor M1. The gate terminal of the transistor M1 is electrically coupled to a first end of a resistor R1. A second end of the resistor R1 is electrically coupled to the terminal Hdr of the integrated circuit 500. That is, the gate signal Hgd output by the integrated circuit 500 is input to the gate terminal of the transistor M1. The source terminal of the transistor M1 is electrically coupled to the terminal Sw of the integrated circuit 500. A conduction state between the drain terminal and the source terminal of the transistor M1 is controlled by the gate signal Hgd input to the gate terminal of the transistor M1.

The drain terminal of the transistor M2 is electrically coupled to the terminal Sw of the integrated circuit 500. That is, the drain terminal of the transistor M2 and the source terminal of the transistor M1 are electrically coupled to each other. The gate terminal of the transistor M2 is electrically coupled to a first end of a resistor R2. A second end of the resistor R2 is electrically coupled to the terminal Ldr of the integrated circuit 500. That is, the gate signal Lgd output by the integrated circuit 500 is input to the gate terminal of the transistor M2. The ground electrical potential is supplied to the source terminal of the transistor M2. A conduction state between the drain terminal and the source terminal of the transistor M2 is controlled by the gate signal Lgd input to the gate terminal of the transistor M2.

In the following description, each of the transistor M1 controlled to be conductive between the drain terminal and the source terminal of the transistor M1 and the transistor M2 controlled to be conductive between the drain terminal and the source terminal of the transistor M2 is referred to as a transistor controlled to be turned on, and each of the transistor M1 controlled to be non-conductive between the drain terminal and the source terminal of the transistor M1 and the transistor M2 controlled to be non-conductive between the drain terminal and the source terminal of the transistor M2 is referred to as a transistor controlled to be turned off.

In the amplifier circuit 550 configured as described above, when the transistor M1 is controlled to be turned off and the transistor M2 is controlled to be turned on, a node to which the terminal Sw is coupled is set to the ground electrical potential. In this case, the voltage signal Vm1 is supplied to the terminal Bst. On the other hand, when the transistor M1 is controlled to be turned on and the transistor M2 is controlled to be turned off, a node to which the terminal Sw is coupled is set to the voltage signal VHV. Therefore, a signal having a voltage value equal to the sum of the voltage value of the voltage signal VHV and the voltage value of the voltage signal Vm1 is supplied to the terminal Bst. That is, the gate driver 521 that drives the transistor M1 uses the capacitor C5 as a floating power source, and the electrical potential of the second end of the capacitor C5 that is equal to the electrical potential of the terminal Sw changes to the ground electrical potential or the voltage value of the voltage signal VHV based on the operations of the transistor M1 and the transistor M2. Therefore, the gate driver 521 generates the L-level gate signal Hgd having a voltage value equal to the voltage value of the voltage signal VHV or the H-level gate signal Hgd having a voltage value equal to the sum of the voltage value of the voltage signal VHV and the voltage value of the voltage signal Vm1, and supplies the generated gate signal Hgd to the gate of the transistor M1.

Meanwhile, the gate driver 522 that drives the transistor M2 generates the L-level gate signal Lgd having a voltage value equal to the ground electrical potential or the H-level gate signal Lgd having a voltage value equal to the voltage value of the voltage signal Vm1 regardless of the operations of the transistors M1 and M2, and supplies the generated gate signal Lgd to the gate terminal of the transistor M2.

As described above, the transistors M1 and M2 operate based on the gate signals Hgd and Lgd, respectively, and thus the amplifier circuit 550 amplifies, based on the voltage signal VHV, the modulated signal Ms obtained by modulating the base drive signal aA obtained by converting the base drive signal dA. Then, the amplifier circuit 550 outputs the amplified signal as the amplified modulated signal AMs from a coupling point where the source terminal of the transistor M1 and the drain terminal of the transistor M2 are commonly coupled. In other words, the amplifier circuit 550 includes the transistor M1 and the transistor M2 that are coupled to each other in a push-pull manner, and outputs the amplified modulated signal AMs from the coupling point where the transistor M1 and the transistor M2 are electrically coupled, by driving the transistor M1 and the transistor M2.

The demodulation circuit 560 includes a filter circuit (not illustrated in FIG. 8), and generates the drive signal COM by smoothing the amplified modulated signal AMs using the filter circuit to demodulate the amplified modulated signal AMs. Then, the demodulation circuit 560 outputs the generated drive signal COM from the drive signal output circuit 51 through a terminal Out. A drive voltage detection signal Vdet is output by the differentiating circuit 580 and input to the demodulation circuit 560. The demodulation circuit 560 changes, based on the input drive voltage detection signal Vdet, a characteristic of the filter that smooths the amplified modulated signal AMs. In addition, the demodulation circuit 560 returns, as a return voltage signal Vrev, a part of a current, which may be generated when the filter characteristic is changed, to a propagation path through which the voltage signal VHV propagates. The configuration and operation of the demodulation circuit 560 will be described in detail later.

The differentiating circuit 580 includes a resistor R7 and a capacitor C7. A first end of the capacitor C7 is electrically coupled to the terminal Out from which the drive signal COM is output. That is, the drive signal COM is supplied to the first end of the capacitor C7. A second end of the capacitor C7 is electrically coupled to a first end of the resistor R7. The ground electrical potential is supplied to a second end of the resistor R7. The differentiating circuit 580 outputs the drive voltage detection signal Vdet from a coupling point where the second end of the capacitor C7 and the first end of the resistor R7 are electrically coupled. That is, the differentiating circuit 580 constitutes a high-pass filter, and outputs a drive voltage detection signal Vdet that is obtained by differentiating the voltage value of the drive signal COM and has a voltage value corresponding to an amount of change in the voltage value of the drive signal COM in a period of time when the voltage value of the drive signal COM changes, and outputs a drive voltage detection signal Vdet that is obtained by differentiating the voltage value of the drive signal COM and has an average voltage value of substantially zero in a period of time when the voltage value of the drive signal COM is constant. In other words, the differentiating circuit 580 outputs a drive voltage detection signal Vdet corresponding to a change in the voltage value of the drive signal COM. The average voltage value of substantially zero is not limited to zero. The case where the average voltage value is substantially zero includes a case where the average voltage value can be regarded to be zero when a variation in a ripple voltage superimposed on the drive signal COM, a variation in a circuit element constituting various circuits including the differentiating circuit 580, superimposed noise, and the like are taken into consideration.

The feedback circuit 570 includes a resistor R3 and a resistor R4. A first end of the resistor R3 is coupled to the terminal Out from which the drive signal COM is output, and a second end of the resistor R3 is coupled to the terminal Vfb and a first end of the resistor R4. The voltage signal VHV is supplied to a second end of the resistor R4. As a result, the drive signal COM that has passed through the feedback circuit 570 from the terminal Out is fed back to the terminal Vfb in a pulled-up state.

The feedback circuit 572 includes capacitors C2, C3, and C4 and resistors R5 and R6. A first end of the capacitor C2 is coupled to the terminal Out from which the drive signal COM is output, and a second end of the capacitor C2 is coupled to a first end of the resistor R5 and a first end of the resistor R6. The ground electrical potential is supplied to a second end of the resistor R5. Thus, the capacitor C2 and the resistor R5 function as a high-pass filter. The cutoff frequency of the high-pass filter is set to about 9 MHZ, for example.

A second end of the resistor R6 is coupled to a first end of the capacitor C4 and a first end of the capacitor C3. The ground electrical potential is supplied to a second end of the capacitor C3. Thus, the resistor R6 and the capacitor C3 function as a low-pass filter. The cutoff frequency of the low-pass filter is set to about 160 MHZ, for example.

As described above, the feedback circuit 572 includes the high-pass filter and the low-pass filter. Accordingly, the feedback circuit 572 functions as a band pass filter that passes a predetermined frequency range of the drive signal COM. A second end of the capacitor C4 included in the feedback circuit 572 is coupled to the terminal Ifb of the integrated circuit 500. Accordingly, a signal in which a direct current component is cut among high frequency components of the drive signal COM that has passed through the feedback circuit 572 that functions as the band pass filter that passes a predetermined frequency component is fed back to the terminal Ifb.

The drive signal COM output from the terminal Out is obtained by smoothing and demodulating the amplified modulated signal AMs based on the base drive signal dA by the demodulation circuit 560. The drive signal COM output by the demodulation circuit 560 passes through the feedback circuit 570 and the terminal Vfb, is integrated and attenuated by the integral attenuator 516, and is fed back to the adder 512. As a result, the drive signal output circuit 51 self-oscillates at a frequency determined based on a delay in the feedback and a feedback transfer function. However, the amount of delay is large if feedback is performed only in a feedback path through the terminal Vfb, and therefore, the frequency of the self-oscillation may not be able to be increased to the extent that the accuracy of the drive signal COM can be sufficiently secured only by the feedback through the terminal Vfb.

The drive signal output circuit 51 according to the present embodiment has a path for feeding back the high-frequency component of the drive signal COM through the feedback circuit 572 and the terminal Ifb, separately from the path through the terminal Vfb. Accordingly, in the drive signal output circuit 51 according to the present embodiment, a delay in the entire circuit configuring the drive signal output circuit 51 is decreased, and the frequency of the voltage signal As can be increased to the extent that the accuracy of the drive signal COM can be sufficiently secured, compared to a case where the path extending through the terminal Ifb is not present.

As described above, the drive signal output circuit 51 according to the present embodiment outputs the drive signal COM for driving the piezoelectric elements 60, and includes the modulation circuit 510 that modulates the base drive signal aA obtained by converting the base drive signal dA on which the drive signal COM is based, and outputs the modulated base drive signal as the modulated signal Ms, the amplifier circuit 550 that amplifies the modulated signal Ms and outputs the amplified modulated signal as the amplified modulated signal AMs, and the demodulation circuit 560 that demodulates the amplified modulated signal AMs and outputs the demodulated signal as the drive signal COM.

### 1.3.2. Configuration and Operation of Demodulation Circuit

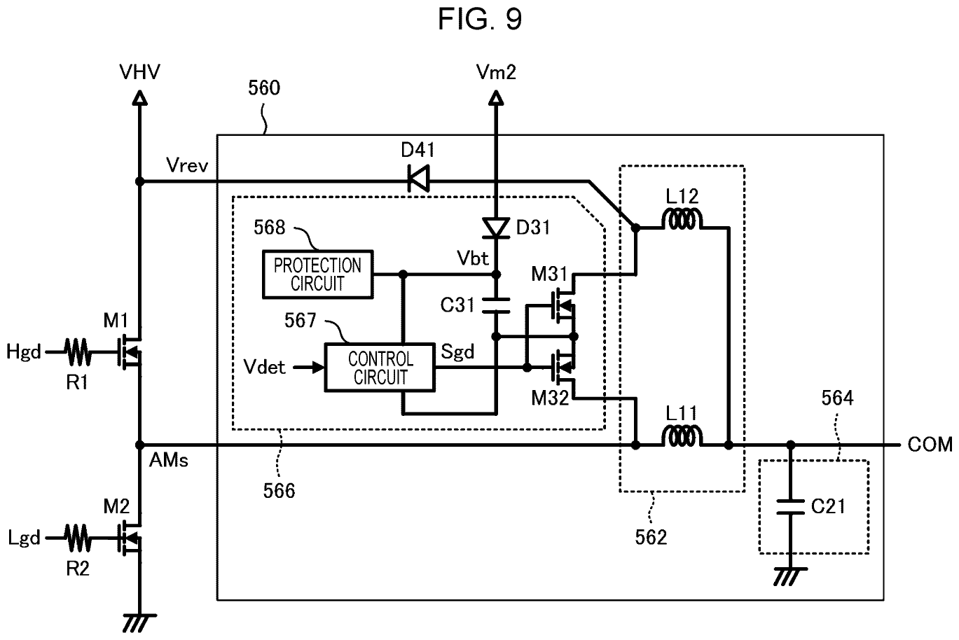

Next, the configuration and operation of the demodulation circuit 560 will be described. FIG. 9 is a diagram illustrating an example of the configuration of the demodulation circuit 560 included in the drive signal output circuit 51. As illustrated in FIG. 9, the demodulation circuit 560 includes an inductive circuit 562, a capacitive circuit 564, a switch circuit 566, and a diode D41. The amplified modulated signal AMs is input to a first end of the inductive circuit 562, and a second end of the inductive circuit 562 is electrically coupled to a first end of the capacitive circuit 564. Further, the ground electrical potential is supplied to a second end of the capacitive circuit 564. That is, the inductive circuit 562 and the capacitive circuit 564 constitute a low-pass filter. The drive signal COM is generated by smoothing the amplified modulated signal AMs by the low-pass filter constituted by the inductive circuit 562 and the capacitive circuit 564. Then, the demodulation circuit 560 outputs the drive signal COM from a coupling point that is an output point of the low-pass filter and at which the second end of the inductive circuit 562 and the first end of the capacitive circuit 564 are electrically coupled.

Specifically, the inductive circuit 562 includes an inductor L11 and an inductor L12, and the capacitive circuit 564 includes a capacitor C21. The amplified modulated signal AMs is input to a first end of the inductor L11 through the first end of the inductive circuit 562. A second end of the inductor L11 is electrically coupled to a first end of the capacitor C21 via the first end of the inductive circuit 562 and the first end of the capacitive circuit 564. A first end of the inductor L12 is electrically coupled to a first end of the switch circuit 566, and a second end of the switch circuit 566 is electrically coupled to the first end of the inductor L11. A second end of the inductor L12 is electrically coupled to the first end of the capacitor C21 via the first end of the inductive circuit 562 and the first end of the capacitive circuit 564. That is, the inductor L11 and the inductor L12 are coupled in parallel via the switch circuit 566 between the first end and the second end of the inductive circuit 562. The second end of the inductor L11 and the second end of the inductor L12 are electrically coupled to the first end of the capacitor C21 via the first end of the inductive circuit 562 and the first end of the capacitive circuit 564. In other words, the demodulation circuit 560 includes a low-pass filter constituted by the inductors L11 and L12 coupled in parallel and the capacitor C21. Then, the demodulation circuit 560 outputs the drive signal COM from a coupling point that is an output point of the low-pass filter and at which the second end of the inductor L11, the second end of the inductor L12, and the first end of the capacitor C21 are electrically coupled.

The switch circuit 566 switches the inductance value of the inductive circuit 562 by switching a conduction state between the first end of the inductor L11 and the first end of the inductor L12.

Specifically, the switch circuit 566 includes a transistor M31, a transistor M32, a capacitor C31, a diode D31, a control circuit 567, and a protection circuit 568. The transistors M31 and M32 are N-channel FETs. The drain terminal of the transistor M32 is electrically coupled to the first end of the inductor L11, the drain terminal of the transistor M31 is electrically coupled to the first end of the inductor L12, and the source terminal of the transistor M32 is electrically coupled to the source terminal of the transistor M31. A common gate signal Sgd output by the control circuit 567 is input to the gate terminal of the transistor M32 and the gate terminal of the transistor M31. In each of the transistors M31 and M32, a conduction state between the drain terminal and the source terminal is controlled by the gate signal Sgd input to the gate terminal.

A power supply terminal of the control circuit 567 on the high electrical potential side is electrically coupled to a first end of the capacitor C31 and the cathode terminal of the diode D31. A second end of the capacitor C31 is electrically coupled to a coupling point where the source terminal of the transistor M31 and the source terminal of the transistor M32 are electrically coupled. A voltage signal Vm2 is supplied to the anode terminal of the diode D31. That is, the capacitor C31 and the diode D31 constitute a bootstrap circuit, and a voltage signal Vbt having a voltage value greater than the voltage value of the coupling point where the source terminal of the transistor M31 and the source terminal of the transistor M32 are coupled by the voltage value of the voltage signal Vm2 is output from a coupling point where the first end of the capacitor C31 and the cathode terminal of the diode D31 are electrically coupled. Therefore, the voltage signal Vbt having the voltage value greater than the voltage value of the coupling point where the source terminal of the transistor M31 and the source terminal of the transistor M32 by the voltage value of the voltage signal Vm2 is supplied to the power supply terminal of the control circuit 567 on the high electrical potential side. The voltage signal Vm2 has the voltage value with which the transistors M31 and M32 can be driven, and is, for example, a direct-current voltage of 7.5 V. In this case, the voltage signal Vm2 may have a voltage equal to the voltage of the voltage signal Vm1 described above, or may have a voltage different from the voltage of the voltage signal Vm1.

In addition, a power supply terminal of the control circuit 567 on the low electrical potential side is electrically coupled to the coupling point where the source terminal of the transistor M31 and the source terminal of the transistor M32 are electrically coupled. That is, the voltage value of the coupling point where the source terminal of the transistor M31 and the source terminal of the transistor M32 are coupled is supplied to the power supply terminal of the control circuit 567 on the low electrical potential side.

The drive voltage detection signal Vdet output by the differentiating circuit 580 is also input to the control circuit 567. The control circuit 567 compares the voltage value of the input drive voltage detection signal Vdet with a predetermined threshold, and generates a signal that is at an H level when the voltage value of the drive voltage detection signal Vdet is greater than the threshold, and is at an L level when the voltage value of the drive voltage detection signal Vdet is less than or equal to the threshold. Then, the control circuit 567 outputs the gate signal Sgd obtained by level-shifting the electrical potential of the generated signal at the H level to the voltage value of the signal supplied to the power supply terminal on the high electrical potential side, and level-shifting the electrical potential of the generated signal at the L level to the voltage value of the signal supplied to the power supply terminal on the low electrical potential side. That is, the control circuit 567 generates an H-level gate signal Sgd having a voltage value that is greater than the voltage value of the coupling point where the source terminal of the transistor M31 and the source terminal of the transistor M32 are coupled by the voltage value of the voltage signal Vm2 or an L-level gate signal Sgd having a voltage value equal to the voltage value of the coupling point where the source terminal of the transistor M31 and the source terminal of the transistor M32 are coupled, and outputs the generated gate signal Sgd to the gate terminal of the transistor M31 and the gate terminal of the transistor M32.

Each of the transistors M31 and M32 is controlled to be conductive between the drain terminal and the source terminal of the transistor when the H-level gate signal Sgd is input to the transistor, and is controlled to be non-conductive between the drain terminal and the source terminal of the transistor when the L-level gate signal Sgd is input to the transistor. That is, the transistors M31 and M32 are controlled to electrically couple the first end of the inductor L11 to the first end of the inductor L12 when the H-level gate signal Sgd is input to the transistors M31 and M32, and are controlled to electrically decouple the first end of the inductor L11 from the first end of the inductor L12 and stop the input of the amplified modulated signal AMs to the first end of the inductor L12 when the amplified modulated signal AMs is input to the first end of the inductor L11 and the L-level gate signal Sgd is input to the transistor M31 and the transistor M32. As described above, the control circuit 567 controls the conduction states of the transistors M31 and M32, that is, the conduction state of the switch circuit 566, based on the drive voltage detection signal Vdet output by the differentiating circuit 580, and the transistors M31 and M32 switch whether to input the amplified modulated signal AMs to the first end of the inductor L11.

When the transistors M31 and M32 are controlled to be non-conductive, the inductance value of the inductive circuit 562 between the first end and the second end of the inductive circuit 562 is set to the inductance value of the inductor L11. When the transistors M31 and M32 are controlled to be conductive, the inductance value of the inductive circuit 562 between the first end and the second end of the inductive circuit 562 is set to a combined inductance value of the inductors L11 and L12 coupled in parallel. That is, the switch circuit 566 controls the conduction states of the transistors M31 and M32 based on the drive voltage detection signal Vdet to switch the inductance value of the inductive circuit 562 between the inductance value of the inductor L11 and the combined inductance value of the inductors L11 and L12 coupled in parallel. The combined inductance value of the inductors L11 and L12 is different from the inductance value of the inductor L11.

The voltage value of the coupling point where the source terminal of the transistor M31 and the source terminal of the transistor M32 are coupled may fluctuate via body diodes of the transistors M31 and M32 or the like. If the voltage value of the coupling point where the source terminal of the transistor M31 and the source terminal of the transistor M32 are coupled fluctuates, an abnormality may occur in the voltage value of the voltage signal Vbt output by the bootstrap circuit constituted by the capacitor C31 and the diode D31. The abnormality in the voltage value of the voltage signal Vbt may cause an abnormality in the voltage value of the gate signal Sgd output by the control circuit 567. If the voltage value of the H-level gate signal Sgd exceeds a gate withstand voltage of the transistors M31 and M32 due to the abnormality in the voltage value of the voltage signal Vbt, an abnormality may occur in the transistors M31 and M32. The protection circuit 568 protects the transistors M31 and M32 by reducing the possibility that an overvoltage may occur in the voltage signal Vbt. The protection circuit 568 may have any configuration as long as the voltage value of the voltage signal Vbt can be limited so as not to exceed a predetermined voltage value, and for example, a Zener diode or the like can be used as the protection circuit 568.

The anode terminal of the diode D41 is electrically coupled to the first end of the inductor L12 and the drain terminal of the transistor M31 that serves as the first end of the switch circuit 566. The voltage signal VHV is supplied to the cathode terminal of the diode D41. When the switch circuit 566 is controlled to be non-conductive between the first end and the second end of the switch circuit 566 in a period of time when a current flows through the inductor L12 in a direction from at least one of the ejection heads 200 to the drive signal output circuit 51, that is, when a current flows through the inductor L12 in a direction from at least one of the ejection heads 200 to the drive signal output circuit 51, the transistor M31 is controlled to be non-conductive between the drain terminal and the source terminal of the transistor M31, and the transistor M32 is controlled to be non-conductive between the drain terminal and the source terminal of the transistor M32, an induced electromotive force corresponding to the inductance value of the inductor L12 and the current flowing through the inductor L12 occurs in the inductor L12. As a result, an overvoltage caused by the induced electromotive force occurs between the first end of the inductor L12 and the drain terminal of the transistor M31 that serves as the first end of the switch circuit 566.

If the overvoltage caused by the induced electromotive force exceeds a withstand voltage between the drain terminal and the source terminal of the transistor M31, an abnormality may occur in the transistor M31. The diode D41 limits an overvoltage that has occurred between the first end of the inductor L12 and the drain terminal of the transistor M31 that serves as the first end of the switch circuit 566 with the voltage signal VHV, and redirects the overvoltage to the voltage signal VHV. Accordingly, it is possible to protect the transistor M31 from the overvoltage caused by the induced electromotive force that has occurred in the inductor L12 and to improve the efficiency of use of electric power in the liquid ejecting apparatus 1 and the drive signal output circuit 51. The demodulation circuit 560 may include, instead

of the above-described diode D41, a metal-oxide-semiconductor FET (MOS-FET) that electrically couples the first end of the inductor L12 and the drain terminal of the transistor M31 that serves as the first end of the switch circuit 566 to the propagation path through which the voltage signal VHV propagates. The conduction state of the MOS-FET is switched based on a voltage value of a node where the first end of the inductor L12 and the drain terminal of the transistor M31 that serves as the first end of the switch circuit 566 are electrically coupled.

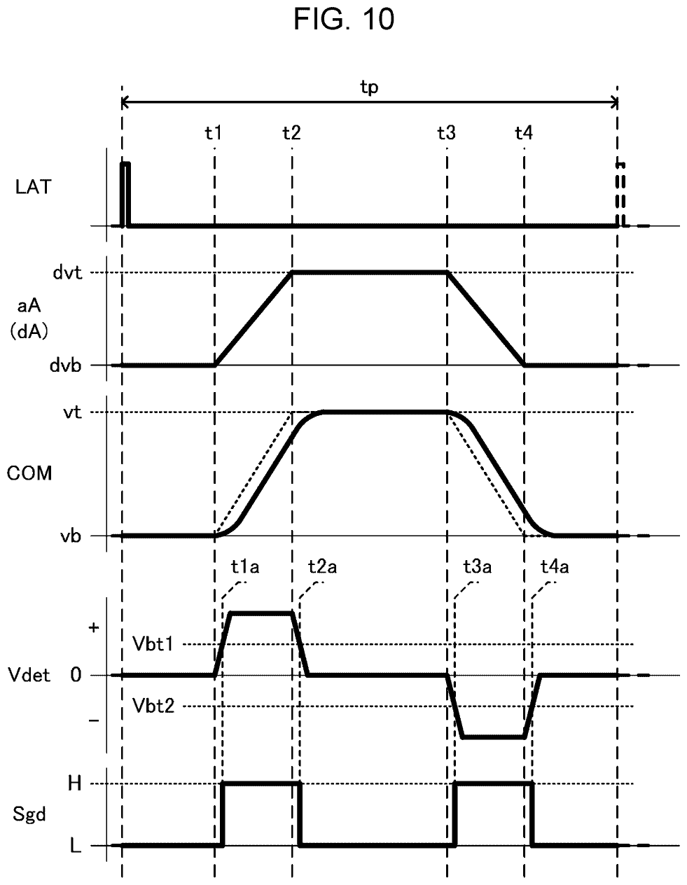

An operation of the demodulation circuit 560 configured as described above will be described. FIG. 10 is a diagram for explaining the operation of the demodulation circuit 560. As illustrated in FIG. 10, in the period tp, the signal waveform of the base drive signal aA defined by the base drive signal dA includes a period of time when the voltage value is constant at a voltage dvb, a period of time when the voltage value is constant at a voltage dvt, a period of time when the voltage value changes from the voltage dvb toward the voltage dvt, and a period of time when the voltage value changes from the voltage dvt toward the voltage dvb. The voltage dvb corresponds to a voltage value before amplification of the voltage vb of the drive signal COM, and the voltage dvt corresponds to a voltage value before amplification of the voltage vt of the drive signal COM.

At a rising edge of the latch signal LAT, the voltage value of the base drive signal aA is constant at the voltage dvb. Therefore, the drive signal output circuit 51 operates such that the voltage value of the output drive signal COM is constant at the voltage vb. In this case, since the voltage value of the drive signal COM is controlled to be constant at the voltage vb, the differentiating circuit 580 outputs the drive voltage detection signal Vdet in which the average value of voltage values is substantially zero. As a result, the control circuit 567 outputs the L-level gate signal Sgd to control the transistors M31 and M32 to be non-conductive. Therefore, the inductance value of the inductive circuit 562 is set to the inductance value of the inductor L11, and the demodulation circuit 560 outputs the drive signal COM obtained by demodulating the amplified modulated signal AMs by a low-pass filter constituted by the inductor L11 and the capacitor C21.

Thereafter, at time t1, the voltage value of the base drive signal aA increases from the voltage dvb toward the voltage dvt. Therefore, the drive signal output circuit 51 operates such that the voltage value of the output drive signal COM increases from the voltage vb toward the voltage vt. In this case, due to the change in the voltage value of the drive signal COM, that is, due to the increase in the voltage value of the drive signal COM, the differentiating circuit 580 outputs the drive voltage detection signal Vdet having a voltage value that increases. At time tla, when the voltage value of the drive voltage detection signal Vdet exceeds a threshold voltage Vbt1, the control circuit 567 switches the logic level of the gate signal Sgd from an L level to an H level. Accordingly, the transistors M31 and M32 are controlled to be conductive. Therefore, the inductance value of the inductive circuit 562 is set to the combined inductance value of the inductors L11 and L12 coupled in parallel. That is, at time tla, the inductance value of the inductive circuit 562 decreases. Then, the demodulation circuit 560 outputs the drive signal COM obtained by demodulating the amplified modulated signal AMs by the low-pass filter constituted by the inductors L11 and L12 coupled in parallel and the capacitor C21.

Thereafter, at time t2, the voltage value of the base drive signal aA is set to be constant at the voltage dvt. Therefore, the drive signal output circuit 51 operates such that the voltage value of the output drive signal COM is constant at the voltage vt. In this case, when the amount of change in the voltage value of the drive signal COM decreases, the differentiating circuit 580 outputs the drive voltage detection signal Vdet having a voltage value that decreases toward zero. Thereafter, at time t2a, when the voltage value of the drive voltage detection signal Vdet falls below the threshold voltage Vbt1, the control circuit 567 switches the logic level of the gate signal Sgd from the H level to the L level. Accordingly, the transistors M31 and M32 are controlled to be non-conductive. Therefore, the inductance value of the inductive circuit 562 is set to the inductance value of the inductor L11. That is, at time t2a, the inductance value of the inductive circuit 562 increases. Then, the demodulation circuit 560 outputs the drive signal COM obtained by demodulating the amplified modulated signal AMs by the low-pass filter constituted by the inductor L11 and the capacitor C21.

Thereafter, at time t3, the voltage value of the base drive signal aA decreases from the voltage dvt toward the voltage dvb. Therefore, the drive signal output circuit 51 operates such that the voltage value of the output drive signal COM decreases from the voltage vt toward the voltage vb. In this case, due to the change in the voltage value of the drive signal COM, that is, due to the decrease in the voltage value of the drive signal COM, the differentiating circuit 580 outputs the drive voltage detection signal Vdet having a voltage value that decreases. At time t3a, when the voltage value of the drive voltage detection signal Vdet falls below the threshold voltage Vbt2, the control circuit 567 switches the logic level of the gate signal Sgd from the L level to the H level. Accordingly, the transistors M31 and M32 are controlled to be conductive. Therefore, the inductance value of the inductive circuit 562 is set to the combined inductance value of the inductors L11 and L12 coupled in parallel. That is, at time t3a, the inductance value of the inductive circuit 562 decreases. Then, the demodulation circuit 560 outputs the drive signal COM obtained by demodulating the amplified modulated signal AMs by the low-pass filter constituted by the inductors L11 and L12 coupled in parallel and the capacitor C21.

Thereafter, at time t4, the voltage value of the base drive signal aA is set to be constant at the voltage dvb. Therefore, the drive signal output circuit 51 operates such that the voltage value of the output drive signal COM is constant at the voltage vb. In this case, when the amount of change in the voltage value of the drive signal COM decreases, the differentiating circuit 580 outputs the drive voltage detection signal Vdet having a voltage value that increases toward zero. At time t4a, when the voltage value of the drive voltage detection signal Vdet exceeds the threshold voltage Vbt1, the control circuit 567 switches the logic level of the gate signal Sgd from the H level to the L level. Accordingly, the transistors M31 and M32 are controlled to be non-conductive. Therefore, the inductance value of the inductive circuit 562 is set to the inductance value of the inductor L11. That is, at time t4a, the inductance value of the inductive circuit 562 increases. Then, the demodulation circuit 560 outputs the drive signal COM obtained by demodulating the amplified modulated signal AMs by the low-pass filter constituted by the inductor L11 and the capacitor C21. Then, at the next rising edge of the latch signal LAT, the period tp ends.

As described above, in the demodulation circuit 560 according to the present embodiment, the control circuit 567 outputs the H-level gate signal Sgd when the difference between the voltage value of the drive voltage detection signal Vdet and zero is greater than the threshold voltage Vbt1 or the threshold voltage Vbt2, and the difference between the absolute value of the voltage value of the drive voltage detection signal Vdet is greater than a predetermined threshold. In the demodulation circuit 560, the control circuit 567 outputs the L-level gate signal Sgd when the difference between the voltage value of the drive voltage detection signal Vdet and zero is less than or equal to the threshold voltage Vbt1 or the threshold voltage Vbt2, and the difference between the absolute value of the voltage value of the drive voltage detection signal Vdet is less than or equal to the predetermined threshold. That is, the control circuit 567 determines, based on the voltage value of the input drive voltage detection signal Vdet, whether the current period is a period of time when the voltage value of the signal waveform that is the voltage value of the drive signal COM and is defined by the base drive signal dA is constant or changes. In at least a period included in a period of time when the voltage value of the signal waveform that is the voltage value of the drive signal COM and is defined by the base drive signal dA changes, the control circuit 567 outputs the H-level gate signal Sgd. In at least a period included in a period of time when the voltage value of the signal waveform that is the voltage value of the drive signal COM and is defined by the base drive signal dA is constant, the control circuit 567 outputs the L-level gate signal Sgd.

Therefore, in at least a period included in a period of time when the voltage value of the signal waveform that is the voltage value of the drive signal COM and is defined by the base drive signal dA changes, the demodulation circuit 560 according to the present embodiment outputs the drive signal COM obtained by demodulating the amplified modulated signal AMs by the low-pass filter constituted by the inductors L11 and L12 coupled in parallel and the capacitor C21. In at least a period included in a period of time when the voltage value of the signal waveform that is the voltage value of the drive signal COM and is defined by the base drive signal dA is constant, the demodulation circuit 560 outputs the drive signal COM obtained by demodulating the amplified modulated signal AMs by the low-pass filter constituted by the inductor 111 and the capacitor C21.

Note that the absolute value of the voltage value of the threshold voltage Vbt1 may be equal to the absolute value of the voltage value of the threshold voltage Vbt2. The differentiating circuit 580 may include a rectifier circuit that rectifies the drive voltage detection signal Vdet, and the control circuit 567 may output the H-level gate signal Sgd when a voltage value of a signal output by the rectifier circuit is greater than a predetermined threshold, and may output the L-level gate signal Sgd when the voltage value of the signal output by the rectifier circuit is less than or equal to the predetermined threshold.

### 1.4. Operation of Liquid Ejecting Apparatus and Demodulation Circuit

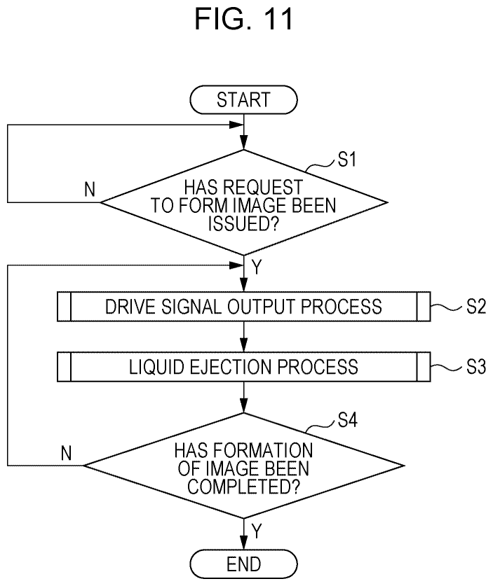

A method of controlling the liquid ejecting apparatus 1 including the drive signal output circuit 51 configured as described above will be described. FIG. 11 is a diagram illustrating an example of the method of controlling the liquid ejecting apparatus 1 including the drive signal output circuit 51.

As illustrated in FIG. 11, when a power supply voltage is applied to the liquid ejecting apparatus 1, the control circuit 100 determines whether a request to form an image on the medium P has been issued (step S1). For example, the request to form the image on the medium P may be issued when an image signal is input to the liquid ejecting apparatus 1 from an external apparatus such as a host computer provided outside the liquid ejecting apparatus 1, or may be issued by an operation of the liquid ejecting apparatus 1 by a user. If the control circuit 100 determines that the request to form the image has not been issued (N in step S1), the liquid ejecting apparatus 1 waits until the request to form the image is issued. On the other hand, if the control circuit 100 determines that the request to form the image has been issued (Y in step S1), the drive signal output circuit 51 performs a drive signal output process (step S2) of outputting a drive signal COM, and each of the ejection heads 200 performs a liquid ejection process (step S3) of ejecting ink toward the medium P based on the drive signal COM output by the drive signal output circuit 51 in the drive signal output process.

The drive signal output process performed by the drive signal output circuit 51 is a process of outputting the drive signal COM obtained by amplifying the signal waveform defined by the base drive signal dA, that is, the drive signal COM obtained by amplifying the signal waveform of the base drive signal aA. Details of the drive signal output process will be described later. In addition, the liquid ejection process performed by each of the ejecting heads 200 is a process in which the ejecting head 200 ejects liquid onto the medium P based on the drive signal COM output by the drive signal output circuit 51 in the drive signal output process, and the print data signal SI and the latch signal LAT output by the control circuit 100. The liquid ejection process includes, for example, the processing described with reference to FIGS. 5 to 7.

After the drive signal output process in step S2 and the liquid ejection process in step S3 are performed, the control circuit 100 determines whether the formation of the image corresponding to the input image signal on the medium P has been completed (step S4). Then, if the control circuit 100 determines that the formation of the image has not been completed (N in step S4), the liquid ejecting apparatus 1 performs the drive signal output process in step S2 and the liquid ejection process in step S3 again. On the other hand, if the control circuit 100 determines that the formation of the image has been completed (Y in step S4), the liquid ejecting apparatus 1 determines that the image corresponding to the image signal input from the external apparatus has been formed on the medium P, and ends the operation. That is, the liquid ejecting apparatus 1 repeatedly performs the drive signal output process in step S2 and the liquid ejection process in step S3 until the formation of the image on the medium P based on the image signal input from the external apparatus such as a host computer is completed.

As described above, the method of controlling the liquid ejecting apparatus 1 that ejects ink onto the medium P in the present embodiment includes the drive signal output process of outputting the drive signal COM obtained by amplifying the base drive signal aA obtained by converting the base drive signal dA, and the liquid ejection process of ejecting ink based on the drive signal COM.

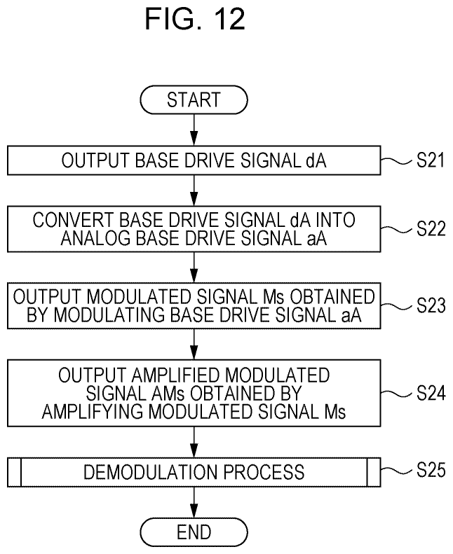

Next, a specific example of the drive signal output process will be described. FIG. 12 is a diagram illustrating a specific example of the drive signal output process. As illustrated in FIG. 12, when the drive signal output process is started, the control circuit 100 generates the base drive signal dA on which the drive signal COM is based, and outputs the base drive signal dA to the drive signal output circuit 51 (step S21).

The base drive signal dA is input to the DAC 511 included in the drive signal output circuit 51. The DAC 511 converts the input base drive signal dA into the base drive signal aA which is an analog signal (step S22). The base drive signal aA is input to the modulation circuit 510. The modulation circuit 510 outputs the modulated signal Ms obtained by modulating the input base drive signal aA (step S23). The modulated signal Ms output by the modulation circuit 510 and the signal obtained by inverting the logic level of the modulated signal Ms output by the modulation circuit 510 are input to the gate drive circuit 520. The gate drive circuit 520 outputs, to the amplifier circuit 550, the gate signal Hgd obtained by level-shifting the input modulated signal Ms and the gate signal Lgd obtained by level-shifting the signal obtained by inverting the logic level of the input modulated signal Ms. Since the gate signal Hgd is obtained by level-shifting the modulated signal Ms and the gate signal Lgd input to the amplifier circuit 550 is obtained by level-shifting the signal obtained by inverting the logic level of the modulated signal Ms, the gate signals Hgd and Lgd input to the amplifier circuit 550 are also obtained by modulating the base drive signal aA.

The amplifier circuit 550 operates based on the gate signals Hgd and Lgd to output the amplified modulated signal AMs. That is, the amplifier circuit 550 outputs the amplified modulated signal AMs obtained by modulating the base drive signal aA and amplifying the modulated signal Ms (step S24). The amplified modulated signal AMs output by the amplifier circuit 550 is input to the demodulation circuit 560. The demodulation circuit 560 performs a demodulation process on the input amplified modulated signal AMs (step S25). By the demodulation process performed by the demodulation circuit 560, the amplified modulated signal AMs is demodulated and output as the drive signal COM.

That is, the drive signal output process includes a process in which the modulation circuit 510 outputs the modulated signal Ms obtained by modulating the base drive signal aA obtained by converting the base drive signal dA, a process in which the amplifier circuit 550 outputs the amplified modulated signal AMs obtained by amplifying the modulated signal Ms, and a process in which the drive signal COM obtained by demodulating the amplified modulated signal AMs is output.

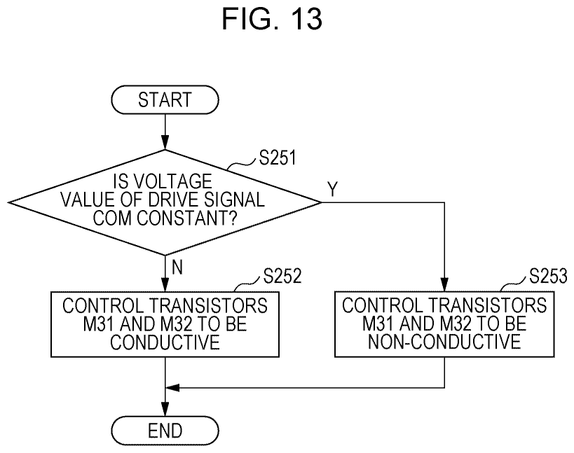

Next, a specific example of the demodulation process will be described. FIG. 13 is a diagram illustrating the specific example of the demodulation process. As illustrated in FIG. 13, in the demodulation process, the control circuit 567 included in the switch circuit 566 determines, based on the input drive voltage detection signal Vdet, whether the voltage value of the drive signal COM is constant (step S251). Specifically, the differentiating circuit 580 differentiates the voltage value of the drive signal COM and outputs the drive voltage detection signal Vdet having a voltage value that is substantially zero in a period of time when the voltage value of the drive signal COM is constant, and that is a positive or negative value based on the amount of change in the voltage value of the drive signal COM in a period of time when the voltage value of the drive signal COM changes. The control circuit 567 determines whether the voltage value of the drive signal COM is constant based on whether the difference between the voltage value of the drive voltage detection signal Vdet and zero is greater than the threshold voltage Vbt1 or the threshold voltage Vbt2, that is, whether the absolute value of the voltage value of the drive voltage detection signal Vdet is greater than the predetermined threshold. In other words, in the demodulation process, the control circuit 567 determines, based on information indicating the differentiation of the drive signal COM, whether the voltage value of the drive signal COM changes or does not change.

If the control circuit 567 determines that the voltage value of the drive signal COM is not constant (N in step S251), the control circuit 567 outputs the H-level gate signal Sgd. Accordingly, the transistors M31 and M32 are controlled to be conductive (step S252). Therefore, the inductance value of the inductive circuit 562 included in the demodulation circuit 560 is controlled to the combined inductance value of the inductors L11 and L12 coupled in parallel. That is, in periods of time when the voltage value of the drive signal COM changes, that is, a period of time when the voltage value of the drive signal COM changes from the voltage vb toward the voltage vt and a period of time when the voltage value of the drive signal COM changes from the voltage vt toward the voltage vb, the demodulation circuit 560 performs a demodulation process of demodulating the amplified modulated signal AMs using the inductive circuit 562 having the combined inductance value of the inductors L11 and L12 coupled in parallel. The combined inductance value of the inductors L11 and L12 is less than the inductance value of the inductor L11. In other words, in the periods of time when the voltage value of the drive signal COM changes, that is, in the period of time when the voltage value of the drive signal COM changes from the voltage vb to the voltage vt and the period of time when the voltage value of the drive signal COM changes from the voltage vt to the voltage vb, the demodulation process of demodulating the amplified modulated signal AMs using the inductors L11 and L12 coupled in parallel is performed.

On the other hand, if the control circuit 567 determines that the voltage value of the drive signal COM is constant (Y in step S251), the control circuit 567 outputs the L-level gate signal Sgd. Accordingly, the transistors M31 and M32 are controlled to be non-conductive (step S253). Therefore, the inductance value of the inductive circuit 562 included in the demodulation circuit 560 is controlled to the inductance value of the inductor L11. That is, in a period of time when the voltage value of the drive signal COM is constant, that is, in a period of time when the voltage value of the drive signal COM is controlled to be constant at the voltage vb or the voltage vt, the demodulation circuit 560 performs a demodulation process of demodulating the amplified modulated signal AMs using the inductive circuit 562 having the inductance value of the inductor L11. In other words, in the period of time when the voltage value of the drive signal COM is constant, that is, in the period of time when the voltage value of the drive signal COM is controlled to be constant at the voltage vb or the voltage vt, the demodulation process of demodulating the amplified modulated signal AMs using the inductor L11 is performed.

Each of the piezoelectric elements 60 is an example of a capacitive load, the drive signal output circuit 51 is an example of a drive signal output circuit, the inductive circuit 562 is an example of an inductive circuit, the capacitive circuit 564 is an example of a capacitive circuit, and the switch circuit 566 is an example of a switch circuit. The inductor L11 is an example of a first inductor element, the inductor L12 is an example of a second inductor element, the capacitor C21 is an example of a capacitor element, the inductance value of the inductor L11 is an example of a first inductance value, and the combined inductance value of the inductors L11 and L12 coupled in parallel is an example of a second inductance value. The diode D41 is an example of a diode element, the transistor M1 is an example of a first transistor element, the transistor M2 is an example of a second transistor element, one of the transistors M31 and M32 is an example of a third transistor element, the transistor M32 is an example of a first FET, the transistor M31 is an example of a second FET, and the differentiating circuit 580 is an example of a drive voltage detection circuit. Further, the voltage signal VHV is an example of an amplification power supply voltage, and the drive voltage detection signal Vdet is an example of a voltage change signal.

### 1.5. Operational Effects

In recent years, a demand for improvement in productivity of a liquid ejecting apparatus has increased, and in response to the increase in the demand, an increase in the frequency of a drive signal for driving a piezoelectric element has been required in high-speed driving of the piezoelectric element for ejecting ink in the liquid ejecting apparatus. However, in a drive signal output circuit including an existing class-D amplifier circuit, there is an advantage that it is possible to reduce power consumption, as compared to a case where a drive signal output circuit includes a class-A amplifier circuit, a class-B amplifier circuit, and a class-AB amplifier circuit, but a demodulation circuit that demodulates an amplified modulated signal and outputs the demodulated signal as a drive signal includes a low-pass filter including an inductor and a capacitor, and there is a new problem in that it is difficult to reduce the possibility that the accuracy of the waveform of the output drive signal may decrease and to achieve a high frequency of the drive signal, while maintaining low power consumption.

Specifically, to increase the frequency of the drive signal by using the drive signal output circuit including the existing class-D amplifier circuit, it is necessary to change the voltage value of the drive signal in a short time. Therefore, it is necessary to shorten the time until a current flowing through the inductor included in the low-pass filter included in the demodulation circuit when the voltage value of the drive signal changes reaches a predetermined current value, and it is necessary to decrease the inductance value of the inductor included in the low-pass filter included in the demodulation circuit. However, when the inductance value of the inductor included in the low-pass filter of the demodulation circuit is decreased, the cutoff frequency of the low-pass filter of the demodulation circuit for demodulating the amplified modulated signal is increased, and the amplitude of a ripple voltage superimposed on the drive signal increases. That is, when the inductance value of the inductor included in the low-pass filter of the demodulation circuit is decreased, the amplitude of the ripple voltage superimposed on the output drive signal increases, and the accuracy of the waveform of the drive signal decreases. The decrease in the accuracy of the waveform is particularly noticeable in a period of time when the voltage value of the drive signal is constant.

To address this problem, by decreasing the inductance value of the inductor included in the low-pass filter of the demodulation circuit and increasing the capacitance value of the capacitor included in the low-pass filter of the demodulation circuit, it is possible to shorten the time until the current flowing through the inductor reaches the predetermined current value and to decrease the cutoff frequency of the low-pass filter of the demodulation circuit that demodulates the amplified modulated signal, and it is also possible to reduce the possibility that the amplitude of the ripple voltage superimposed on the drive signal may increase. However, when the capacitance value of the capacitor included in the low-pass filter of the demodulation circuit is increased, the current flowing through the inductor increases as the capacitor is charged, and as a result, the power consumption in the drive signal output circuit increases. That is, when the inductance value of the inductor included in the low-pass filter is decreased in a state where the cutoff frequency of the low-pass filter included in the demodulation circuit is substantially constant, the capacitance value of the capacitor included in the low-pass filter increases, and low power consumption that is one of advantages of the drive signal output circuit using the class-D amplifier circuit is not achieved.

As described above, in the drive signal output circuit including the class-D amplifier circuit, a trade-off relationship is present between an increase in the frequency of the drive signal to be output, an improvement in the accuracy of the waveform of the drive signal, and a reduction in power consumption in the drive signal output circuit. Therefore, it is difficult to reduce the possibility that the accuracy of the waveform of the drive signal to be output may decrease and to achieve a high frequency of the drive signal while maintaining low power consumption in the drive signal output circuit including the existing class-D amplifier circuit.

To address this problem, in the drive signal output circuit 51 of the liquid ejecting apparatus 1 according to the first embodiment, the demodulation circuit 560 includes the inductive circuit 562, the capacitive circuit 564, and the switch circuit 566, the amplified modulated signal AMs is input to the first end of the inductive circuit 562, the second end of the inductive circuit 562 is electrically coupled to the first end of the capacitive circuit 564, the ground electrical potential is supplied to the second end of the capacitive circuit 564, whereby the inductive circuit 562 and the capacitive circuit 564 constitute the low-pass filter, and the switch circuit 566 switches the inductance value of the low-pass filter constituted by the inductive circuit 562 and the capacitive circuit 564, that is, the inductance value of the inductive circuit 562.

In the period tp, in a period of time that is until the current flowing through the inductive circuit 562 reaches the predetermined current value and is desired to be shortened and a period of time when the voltage value of the drive signal COM changes, in the drive signal output circuit 51 configured as described above in the first embodiment, the switch circuit 566 switches the inductance value of the inductive circuit 562 to a smaller value so as to achieve a high frequency of the drive signal COM. In the period tp, in a period of time when a ripple voltage superimposed on the signal waveform of the drive signal COM may be noticeable and a period of time when the voltage value of the drive signal COM is constant, in the drive signal output circuit 51, the switch circuit 566 switches the inductance value of the inductive circuit 562 to a larger value so as to decrease the amplitude of the ripple voltage superimposed on the signal waveform of the drive signal COM and to reduce the possibility that the signal waveform of the drive signal COM may degrade. Further, in this case, the capacitance value of the capacitive circuit 564 is constant regardless of the operation of the switch circuit 566. Therefore, the possibility that power consumption in the drive signal output circuit 51 may increase is also reduced.

That is, in the drive signal output circuit 51 included in the liquid ejecting apparatus 1 according to the first embodiment, the switch circuit 566 has a characteristic configuration for switching the inductance value of the inductive circuit 562 that is the inductance value of the low-pass filter configured by the inductive circuit 562 and the capacitive circuit 564, and thus it is possible to reduce the possibility that the accuracy of the waveform of the output drive signal COM may decrease and to achieve a high frequency of the drive signal COM while maintaining low power consumption in the drive signal output circuit 51.

In addition, in the drive signal output circuit 51 of the liquid ejecting apparatus 1 according to the present embodiment, the inductive circuit 562 included in the demodulation circuit 560 includes the inductor L11 and the inductor L12, and the capacitive circuit 564 included in the demodulation circuit 560 includes the capacitor C21. The amplified modulated signal AMs is input to the first end of the inductor L11, the second end of the inductor L11 is electrically coupled to the first end of the capacitor C21, the first end of the inductor L12 is electrically coupled to the first end of the switch circuit 566, the second end of the switch circuit 566 is electrically coupled to the first end of the inductor L11, the second end of the inductor L12 is electrically coupled to the first end of the capacitor C21, and the ground electrical potential is supplied to the second end of the capacitor C21. That is, when the first end and the second end of the switch circuit 566 are controlled to be non-conductive, the demodulation circuit 560 outputs the drive signal COM obtained by demodulating the amplified modulated signal AMs by the low-pass filter constituted by the inductor L11 and the capacitor C21. When the first end and the second end of the switch circuit 566 are controlled to be conductive, the demodulation circuit 560 outputs the drive signal COM obtained by demodulating the amplified modulated signal AMs by the low-pass filter constituted by the inductors L11 and L12 coupled in parallel and the capacitor C21. In other words, the switch circuit 566 switches the inductance value of the inductive circuit 562 included in the demodulation circuit 560 between the inductance value of the inductor L11 and the combined inductance value of the inductors L11 and L12 coupled in parallel. The combined inductance value of the inductors L11 and L12 is less than the inductance value of the inductor L11.

In the period tp, in a period of time that is until the current flowing through the inductive circuit 562 reaches the predetermined current value and is desired to be shortened and a period of time when the voltage value of the drive signal COM changes, in the drive signal output circuit 51 included in the demodulation circuit 560 configured as described above in the first embodiment, the switch circuit 566 switches the inductance value of the inductive circuit 562 to the combined inductance value of the inductors L11 and L12 coupled in parallel so as to decrease the inductance value of the inductive circuit 562 and achieve a high frequency of the drive signal COM. In the period tp, in a period of time when a ripple voltage superimposed on the signal waveform of the drive signal COM may be noticeable and a period of time when the voltage value of the drive signal COM is constant, in the drive signal output circuit 51, the switch circuit 566 switches the inductance value of the inductive circuit 562 to the inductance value of the inductor L11 so as to increase the inductance value of the inductive circuit 562 and reduce the possibility that the signal waveform of the drive signal COM may degrade due to the ripple voltage superimposed on the signal waveform of the drive signal COM. Further, in this case, the capacitance value of the capacitive circuit 564 is constant at the capacitance value of the capacitor C21 regardless of the operation of the switch circuit 566. Therefore, the possibility that power consumption in the drive signal output circuit 51 may increase is also reduced.

Accordingly, in the drive signal output circuit 51 that is included in the liquid ejecting apparatus 1 according to the first embodiment and includes the demodulation circuit 560 having the above-described configuration, it is possible to reduce the possibility that the accuracy of the waveform of the output drive signal COM may decrease and to achieve a high frequency of the drive signal COM while maintaining low power consumption in the drive signal output circuit 51.

It is preferable that the inductance value of the inductor L11 be greater than the inductance value of the inductor L12. That is, it is preferable that the inductance value of the inductor L12 be less than the inductance value of the inductor L11. Therefore, the combined inductance value of the inductors L11 and L12 coupled in parallel can be set to be sufficiently less than the inductance value of the inductor L11. As a result, in a period of time when the voltage value of the drive signal COM changes, it is possible to further shorten the time required for the current flowing through the inductive circuit 562 to reach the predetermined current value, and to achieve a higher frequency of the drive signal COM.

In addition, the on-resistance of the transistor M1 included in the amplifier circuit 550 and the on-resistance of the transistor M2 included in the amplifier circuit 550 may be higher than the on-resistance of each of the transistors M31 and M32 included in the switch circuit 566. That is, the on-resistance of each of the transistors M31 and M32 included in the switch circuit 566 may be lower than the on-resistance of the transistor M1 included in the amplifier circuit 550 and the on-resistance of the transistor M2 included in the amplifier circuit 550. As described above, the drive frequencies of the transistors M1 and M2 are about several MHz, whereas the drive frequencies of the transistors M31 and M32 are in a range of about several 10 KHz to 100 KHz. Therefore, an element having a large input capacitance can be selected for each of the transistors M31 and M32, and an element having low on-resistance can be selected for each of the transistors M31 and M32, as compared with the transistors M1 and M2. By using elements having low on-resistance as the transistors M31 and M32, it is possible to further shorten the time required for the current flowing through the inductive circuit 562 to reach the predetermined current value in a period of time when the voltage value of the drive signal COM changes. By using the elements having low on-resistance as the transistors M31 and M32, the possibility that distortion may occur in the signal waveform of the drive signal COM due to the on-resistance of the transistors M31 and M32 is reduced, and a loss in the transistors M31 and M32 is reduced. Therefore, it is also possible to achieve further power saving in the drive signal output circuit 51.

In addition, in the method of controlling the liquid ejecting apparatus 1 according to the first embodiment, in a period of time when the voltage value of the drive signal COM is constant, that is, in a period of time when the voltage value of the drive signal COM is controlled to be constant at the voltage vb or the voltage vt, the demodulation circuit 560 performs the demodulation process of demodulating the amplified modulated signal AMs using the inductive circuit 562 having the inductance value of the inductor L11. In addition, in the method of controlling the liquid ejecting apparatus 1 according to the first embodiment, in periods of time when the voltage value of the drive signal COM changes, that is, in a period of time when the voltage value of the drive signal COM changes from the voltage vb toward the voltage vt and a period of time when the voltage value of the drive signal COM changes from the voltage vt toward the voltage vb, the demodulation circuit 560 performs the demodulation process of demodulating the amplified modulated signal AMs using the inductive circuit 562 having the combined inductance value of the inductors L11 and L12 coupled in parallel. The combined inductance value of the inductors L11 and L12 coupled in parallel is less than the inductance value of the inductor L11.

As a result, in the period tp, in a period of time that is until the current flowing through the inductive circuit 562 reaches the predetermined current value and is desired to be shorten and a period of time when the voltage value of the drive signal COM changes, it is possible to decrease the inductance value of the demodulation circuit 560 and achieve a high frequency of the drive signal COM. In the period tp, in a period of time when a ripple voltage superimposed on the signal waveform of the drive signal COM may be noticeable and a period of time when the voltage value of the drive signal COM is constant, it is possible to increase the inductance value of the demodulation circuit 560, decrease the amplitude of the ripple voltage superimposed on the signal waveform of the drive signal COM, and reduce the possibility that the signal waveform of the drive signal COM may degrade. In this case, since the capacitance value of the capacitive circuit 564 is constant, the possibility that power consumption in the drive signal output circuit 51 may increase is also reduced. That is, in the method of controlling the liquid ejecting apparatus 1 according to the first embodiment, by switching, based on the voltage value of the drive signal COM, the inductance value of the inductive circuit 562 that is the inductance value of the low-pass filter constituted by the inductive circuit 562 and the capacitive circuit 564, it is possible to reduce the possibility that the accuracy of the waveform of the output drive signal COM may decrease and to achieve a high frequency of the drive signal COM, while maintaining low power consumption in the drive signal output circuit 51.

In addition, in the method of controlling the liquid ejecting apparatus 1 according to the first embodiment, in a period of time when the voltage value of the drive signal COM is constant, that is, in a period of time when the voltage value of the drive signal COM is controlled to be constant at the voltage vb or the voltage vt, the demodulation process of demodulating the amplified modulated signal AMs using the inductor L11 is performed. In the method of controlling the liquid ejecting apparatus 1 according to the first embodiment, in periods of time when the voltage value of the drive signal COM changes, that is, in a period of time when the voltage value of the drive signal COM changes from the voltage vb toward the voltage vt and a period of time when the voltage value of the drive signal COM changes from the voltage vt toward the voltage vb, the demodulation process of demodulating the amplified modulated signal AMs using the inductors L11 and L12 coupled in parallel is performed.

As a result, in the period tp, in a period of time that is until the current flowing through the inductive circuit 562 reaches the predetermined current value and is desired to be shortened and a period of time when the voltage value of the drive signal COM changes, the inductance value of the inductive circuit 562 is switched to the combined inductance value of the inductors L11 and L12 coupled in parallel, the inductance value of the demodulation circuit 560 is decreased, and it is possible to achieve a high frequency of the drive signal COM. In the period tp, in a period of time when a ripple voltage superimposed on the signal waveform of the drive signal COM may be noticeable and a period of time when the voltage value of the drive signal COM is constant, the inductance value of the inductive circuit 562 is switched to the inductance value of the inductor L11, the inductance value of the demodulation circuit 560 is increased, and it is possible to decrease the amplitude of the ripple voltage superimposed on the signal waveform of the drive signal COM, and reduce the possibility that the signal waveform of the drive signal COM may degrade. In this case, since the capacitance value of the capacitive circuit 564 is constant at the capacitance value of the capacitor C21 regardless of the operation of the switch circuit 566, the possibility that the power consumption in the drive signal output circuit 51 may increase is also reduced. Accordingly, in the method of controlling the liquid ejecting apparatus 1 according to the first embodiment including the demodulation circuit 560 having the above-described configuration, it is possible to reduce the possibility that the accuracy of the waveform of the output drive signal COM may decrease and to achieve a high frequency of the drive signal COM while maintaining low power consumption in the drive signal output circuit 51.

### 1.6. Modifications

In the liquid ejecting apparatus 1, the drive signal output circuit 51, and the control method of the liquid ejecting apparatus 1 according to the first embodiment described above, the inductive circuit 562 included in the demodulation circuit 560 includes the inductors L11 and L12 coupled in parallel, and the switch circuit 566 switches the inductance value of the inductive circuit 562 between the inductance value of the inductor L11 and the combined inductance value of the inductors L11 and L12 coupled in parallel. However, the configuration is not limited thereto as long as the inductance value of the inductive circuit 562 constituting the low-pass filter in the demodulation circuit 560 can be switched.

### 1.6.1. First Modification

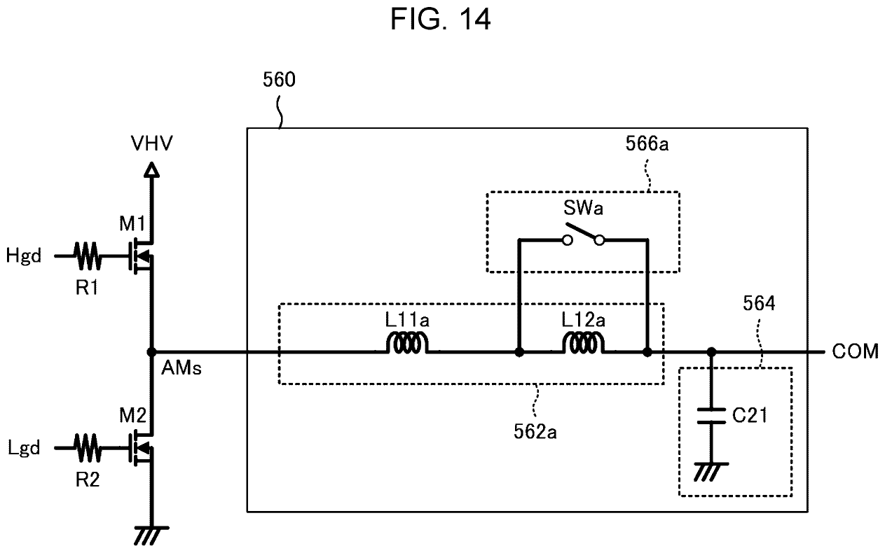

FIG. 14 is a diagram illustrating an example of a configuration of a demodulation circuit 560 according to a first modification. As illustrated in FIG. 14, in the demodulation circuit 560 according to the first modification, an inductive circuit 562a included in the demodulation circuit 560 includes inductors L11a and L12a coupled in series, and a switch circuit 566a that switches the inductance value of the inductive circuit 562a between the inductance value of the inductor Llla and a combined inductance value of the inductors L11a and L12a coupled in series.

Specifically, as illustrated in FIG. 14, the demodulation circuit 560 according to the first modification includes the inductive circuit 562a, the capacitive circuit 564, and the switch circuit 566a. The inductive circuit 562a includes the inductor Llla and the inductor L12a, and the capacitive circuit 564 includes the capacitor C21. The amplified modulated signal AMs is input to a first end of the inductor Llla, a second end of the inductor Llla is electrically coupled to a first end of the inductor L12a, and a second end of the inductor L12a is electrically coupled to a first end of the capacitor C21. Further, a first end of the switch circuit 566a is electrically coupled to the first end of the inductor L12a, and a second end of the switch circuit 566a is electrically coupled to the second end of the inductor L12a. The demodulation circuit 560 outputs the drive signal COM from a coupling point where the second end of the inductor L12a and the first end of the capacitor C21 are electrically coupled.

In the demodulation circuit 560 configured as described above in the first modification, the inductance value of the inductive circuit 562a is switched to the combined inductance value of the inductors Llla and L12a coupled in series in a period of time when a switch SWa included in the switch circuit 566a is controlled to be non-conductive, and is switched to the inductance value of the inductor L11a in a period of time when the switch SWa included in the switch circuit 566a is controlled to be conductive. The inductance value of the inductor Llla is less than the combined inductance value of the inductors L11a and L12a coupled in series. That is, the switch circuit 566a switches the inductance value of the inductive circuit 562a by switching the conduction state of the first end and the second end of the inductor L12a.

In the period tp, in a period of time that is until a current flowing through the inductive circuit 562a reaches a predetermined current value and is desired to be shortened and a period of time when the voltage value of the drive signal COM changes, in the drive signal output circuit 51 including the demodulation circuit 560 configured as described above in the first modification, the switch circuit 566a switches the inductance value of the inductive circuit 562a to the inductance value of the inductor Llla to decrease the inductance value of the inductive circuit 562a and achieve a high frequency of the drive signal COM. In the period tp, in a period of time when a ripple voltage superimposed on the signal waveform of the drive signal COM may be noticeable and a period of time when the voltage value of the drive signal COM is constant, in the drive signal output circuit 51, the switch circuit 566a switches the inductance value of the inductive circuit 562a to the combined inductance value of the inductors Lla and L12a coupled in series to increase the inductance value of the inductive circuit 562a and reduce the possibility that the signal waveform of the drive signal COM may degrade due to the ripple voltage superimposed on the signal waveform of the drive signal COM. In this case, the capacitance value of the capacitive circuit 564 is constant at the capacitance value of the capacitor C21 regardless of the operation of the switch circuit 566a. Therefore, the possibility that power consumption in the drive signal output circuit 51 may increase is also reduced. That is, operational effects similar to those of the liquid ejecting apparatus 1 and the drive signal output circuit 51 according to the first embodiment described above are obtained.

In a method of controlling the liquid ejecting apparatus 1 including the demodulation circuit 560 according to the first modification, in a period of time when the voltage value of the drive signal COM is constant, that is, in a period of the voltage value of the drive signal COM is controlled to be constant at the voltage vb or the voltage vt, the demodulation circuit 560 performs a demodulation process of demodulating the amplified modulated signal AMs using the inductive circuit 562a having the combined inductance value of the inductors Llla and L12a coupled in series. In other words, in a period of time when the voltage value of the drive signal COM is constant, that is, in a period of time when the voltage value of the drive signal COM is controlled to be constant at the voltage vb or the voltage vt, the demodulation process of demodulating the amplified modulated signal AMs is performed using the inductors L11a and L12a coupled in series.

On the other hand, in periods of time when the voltage value of the drive signal COM changes, that is, in a period of time when the voltage value of the drive signal COM changes from the voltage vb toward the voltage vt and a period of time when the voltage value of the drive signal COM changes from the voltage vt toward the voltage vb, the demodulation circuit 560 performs a demodulation process of demodulating the amplified modulated signal AMs using the inductive circuit 562a having the inductance value of the inductor L11a. In other words, in the periods of time when the voltage value of the drive signal COM changes, that is, in the period of time when the voltage value of the drive signal COM changes from the voltage vb toward the voltage vt and the period of time when the voltage value of the drive signal COM changes from the voltage vt toward the voltage vb, the demodulation process of demodulating the amplified modulated signal AMs is performed using the inductor L11a.

Even in the method of controlling the liquid ejecting apparatus 1 that includes the demodulation circuit 560 having the above-described configuration and performs the demodulation process, operational effects similar to those obtained in the method of controlling the liquid ejecting apparatus 1 according to the first embodiment described above are obtained.

The switch SWa included in the switch circuit 566a may be capable of switching a conduction state between the first end and the second end of the inductor L12a, and may have the same configuration as that of the switch circuit 566 described above. In this case, a control circuit 567 included in the switch SWa may output the H-level gate signal Sgd when the voltage value of the input drive voltage detection signal Vdet is greater than a predetermined threshold, and may output the L-level gate signal Sgd when the voltage value of the input drive voltage detection signal Vdet is less than or equal to the predetermined threshold. Alternatively, the control circuit 567 included in the switch SWa may output the H-level gate signal Sgd when the voltage value of the input drive voltage detection signal Vdet is less than or equal to the predetermined threshold, and may output the L-level gate signal Sgd when the voltage value of the input drive voltage detection signal Vdet is greater than the predetermined threshold.

In the first modification, the inductive circuit 562a is an example of the inductive circuit, the inductor L11a is an example of the first inductor element, the inductor L12a is an example of the second inductor element, the capacitor C21 is an example of the capacitor element, the inductance value of the inductor Lila is an example of the first inductance value, and the combined inductance value of the inductors L11a and L12a coupled in series is an example of the second inductance value.

### 1.6.2. Second Modification

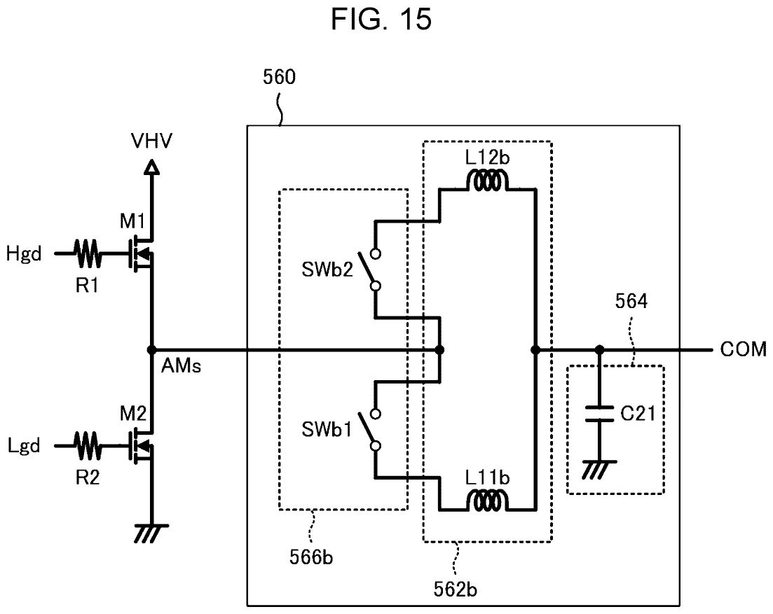

FIG. 15 is a diagram illustrating an example of a configuration of a demodulation circuit 560 according to a second modification. As illustrated in FIG. 15, in the demodulation circuit 560 according to the second modification, an inductive circuit 562b included in the demodulation circuit 560 includes an inductor L11b and an inductor L12b, and a switch circuit 566b that switches the inductance value of the inductive circuit 562b between the inductance value of the inductor L11b and the inductance value of the inductor L12b.

Specifically, as illustrated in FIG. 15, the demodulation circuit 560 according to the second modification includes the inductive circuit 562b, the capacitive circuit 564, and the switch circuit 566b. The inductive circuit 562b includes the inductor L11b and the inductor L12b, and the capacitive circuit 564 includes the capacitor C21. A first end of the inductor L11b is electrically coupled to a first end of a switch SWb1 included in the switch circuit 566b, and a first end of the inductor L12b is electrically coupled to a first end of a switch SWb2 included in the switch circuit 566b. A second end of the inductor L11b and a second end of the inductor L12b are electrically coupled to a first end of the capacitor C21. In addition, the amplified modulated signal AMs is input to a coupling point that is an input terminal of the switch circuit 566b and at which a second end of the switch SWb1 and a second end of the switch SWb2 are electrically coupled. That is, the switch circuit 566b outputs, from the first end of the switch SWb1 or the first end of the switch SWb2, the amplified modulated signal AMs input to the coupling point where the second end of the switch SWb1 and the second end of the switch SWb2 are electrically coupled. In other words, in the switch circuit 566b, the coupling point where the second end of the switch SWb1 and the second end of the switch SWb2 are electrically coupled corresponds to the input terminal to which the amplified modulated signal AMs is input, and each of the first end of the switch SWb1 and the first end of the switch SWb2 corresponds to an output terminal from which the amplified modulated signal AMs is output. In addition, the switch circuit 566b switches whether to electrically couple the first end to the second end of the switch SWb1 and whether to electrically couple the first end to the second end of the switch SWb2, and the demodulation circuit 560 outputs the drive signal COM from a coupling point where the second end of the inductor L11b, the second end of the inductor L12b, and the first end of the capacitor C21 are electrically coupled.

In the demodulation circuit 560 configured as described above in the second modification, the switches SWb1 and SWb2 are controlled to be exclusively conductive. Specifically, the switches SWb1 and SWb2 have a configuration similar to that of the switch circuit 566 described above. One of a control circuit 567 included in the switch SWb1 and a control circuit 567 included in the switch SWb2 outputs the H-level gate signal Sgd when the voltage value of the input drive voltage detection signal Vdet is greater than the predetermined threshold, and outputs the L-level gate signal Sgd when the voltage value of the input drive voltage detection signal Vdet is less than or equal to the predetermined threshold, and the other of the control circuit 567 included in the switch SWb1 and the control circuit 567 included in the switch SWb2 outputs the H-level gate signal Sgd when the voltage value of the input drive voltage detection signal Vdet is less than or equal to the predetermined threshold, and outputs the L-level gate signal Sgd when the voltage value of the input drive voltage detection signal Vdet is greater than the predetermined threshold.

In the demodulation circuit 560 configured as described above in the second modification, in a period of time when the switch SWb1 included in the switch circuit 566b is controlled to be conductive and the switch SWb2 included in the switch circuit 566b is controlled to be non-conductive, the inductance value of the inductive circuit 562b is switched to the inductance value of the inductor L11b, and in a period of time when the switch SWb1 included in the switch circuit 566b is controlled to be non-conductive and the switch SWb2 included in the switch circuit 566b is controlled to be conductive, the inductance value of the inductive circuit 562b is switched to the inductance value of the inductor L12b. That is, the switch circuit 566b switches the inductance value of the inductive circuit 562b by switching the conduction state of each of the switches SWb1 and SWb2.

In the period tp, in a period of time that is until a current flowing through the inductive circuit 562b reaches a predetermined current value and is desired to be shortened and a period of time when the voltage value of the drive signal COM changes, in the drive signal output circuit 51 including the demodulation circuit 560 configured as described above in the second modification, the switch circuit 566b selects, as the inductance value of the inductive circuit 562b, a smaller one of the inductance value of the inductor L11b and the inductance value of the inductor L12b and switches the inductance value of the inductive circuit 562b to the selected inductance value. Thus, the inductance value of the inductive circuit 562b is decreased, and a high frequency of the drive signal COM is achieved. Meanwhile, in the period tp, in a period of time when a ripple voltage superimposed on the signal waveform of the drive signal COM may be noticeable and a period of time when the voltage value of the drive signal COM is constant, the switch circuit 566b selects, as the inductance value of the inductive circuit 562b, a larger one of the inductance value of the inductor L11b and the inductance value of the inductor L12b and switches the inductance value of the inductive circuit 562b to the selected inductance value. Thus, the inductance value of the inductive circuit 562b is increased, and the possibility that the signal waveform of the drive signal COM may degrade due to the ripple voltage superimposed on the signal waveform of the drive signal COM is reduced. In this case, the capacitance value of the capacitive circuit 564 is constant at the capacitance value of the capacitor C21 regardless of the operation of the switch circuit 566b. Therefore, the possibility that power consumption in the drive signal output circuit 51 may increase is also reduced. That is, operational effects similar to those of the liquid ejecting apparatus 1 and the drive signal output circuit 51 according to the first embodiment described above are obtained.

In the method of controlling the liquid ejecting apparatus 1 including the demodulation circuit 560 according to the second modification, in a period of time when the voltage value of the drive signal COM is constant, that is, in a period of time when the voltage value of the drive signal COM is controlled to be constant at the voltage vb or the voltage vt, the demodulation circuit 560 performs a demodulation process of demodulating the amplified modulated signal AMs using the inductive circuit 562b having the larger inductance value out of the inductance value of the inductor L11b and the inductance value of the inductor L12b. In other words, in the period of time when the voltage value of the drive signal COM is constant, that is, in the period of time when the voltage value of the drive signal COM is controlled to be constant at the voltage vb or the voltage vt, the demodulation process of demodulating the amplified modulated signal AMs is performed using the inductor element having the larger inductance value out of the inductance value of the inductor L11b and the inductance value of the inductor L12b.

Meanwhile, in periods of time when the voltage value of the drive signal COM changes, that is, in a period of time when the voltage value of the drive signal COM changes from the voltage vb toward the voltage vt and a period of time when the voltage value of the drive signal COM changes from the voltage vt toward the voltage vb, the demodulation circuit 560 performs a demodulation process of demodulating the amplified modulated signal AMs using the inductive circuit 562b having the smaller inductance value out of the inductance value of the inductor L11b and the inductance value of the inductor L12b. In other words, in the periods of time when the voltage value of the drive signal COM changes, that is, in the period of time when the voltage value of the drive signal COM changes from the voltage vb to the voltage vt and the period of time when the voltage value of the drive signal COM changes from the voltage vt to the voltage vb, the demodulation process of demodulating the amplified modulated signal AMs is performed using the inductor element having the smaller inductance value out of the inductance value of the inductor L11b and the inductance value of the inductor L12b.

Even in the method of controlling the liquid ejecting apparatus 1 that includes the demodulation circuit 560 having the above-described configuration and performs the demodulation process, operational effects similar to those obtained in the method of controlling the liquid ejecting apparatus 1 according to the first embodiment described above are obtained.

The inductive circuit 562b is an example of the inductive circuit, the inductor L11b is an example of the first inductor element, the inductor L12b is an example of the second inductor element, the capacitor C21 is an example of the capacitor element, the inductance value of the inductor L11b is an example of the first inductance value, the inductance value of the inductor L12b is an example of the second inductance value, the first end of the switch SWb1 is an example of a first output terminal, the first end of the switch SWb2 is an example of a second output terminal, and the coupling point where the second end of the switch SWb1 and the second end of the switch SWb2 are electrically coupled is an example of an input terminal.

### 2. Second Embodiment

Next, a liquid ejecting apparatus 1 and a drive signal output circuit 51 according to a second embodiment will be described. In the liquid ejecting apparatus 1 according to the second embodiment, the switch circuit 566 included in the demodulation circuit 560 switches the inductance value of the inductive circuit 562 based on the result of determining whether the value of the base drive signal dA is constant in addition to the result of determining whether the voltage value of the drive signal COM based on the drive voltage detection signal Vdet output by the differentiating circuit 580 is constant. This feature is different from the liquid ejecting apparatus 1 according to the first embodiment. In the description of the liquid ejecting apparatus 1 and the drive signal output circuit 51 according to the second embodiment, the same components as those of the liquid ejecting apparatus 1 and the drive signal output circuit 51 according to the first embodiment are denoted by the same reference signs, and the description thereof will be omitted or simplified.

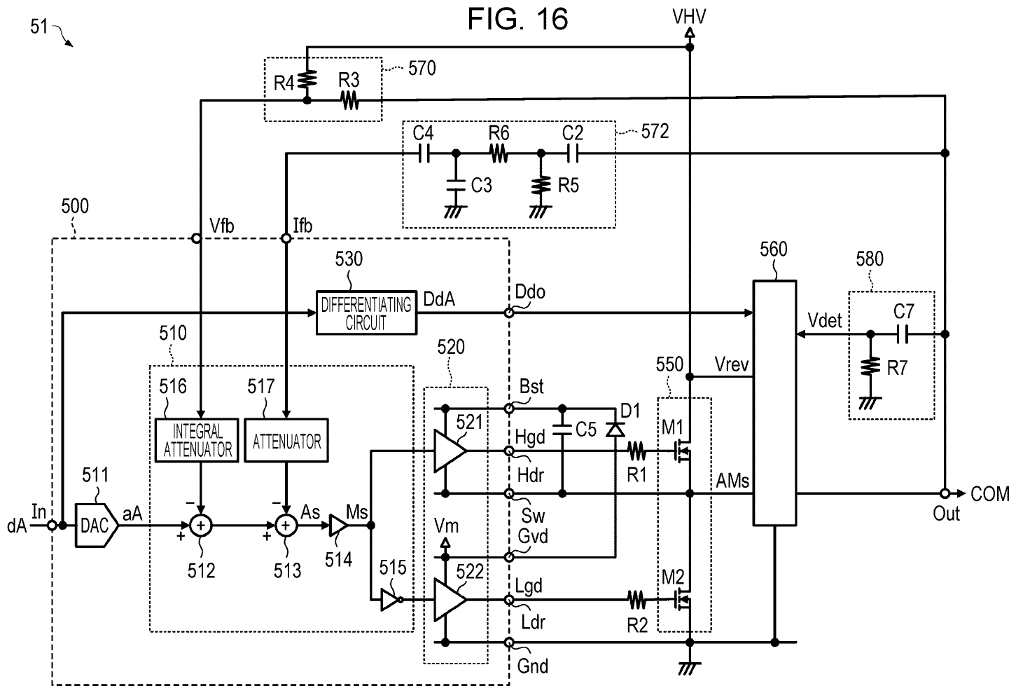

FIG. 16 is a diagram illustrating a configuration of the drive signal output circuit 51 according to the second embodiment. As illustrated in FIG. 16, the drive signal output circuit 51 according to the second embodiment further includes a differentiating circuit 530 in addition to the drive signal output circuit 51 according to the first embodiment. The base drive signal dA is input to the differentiating circuit 530. Then, in a period of time when the value of the input base drive signal dA changes, the differentiating circuit 530 generates a H-level base drive differentiation signal DdA. In a period of time when the value of the input base drive signal dA does not change, the differentiating circuit 530 generates an L-level base drive differentiation signal DdA. The differentiating circuit 530 outputs the generated base drive differentiation signal DdA to the demodulation circuit 560. The differentiating circuit 530 may receive the base drive signal aA instead of the base drive signal dA. The differentiating circuit 530 may generate the H-level base drive differentiation signal DdA in a period of time when the voltage value of the input base drive signal aA changes. The differentiating circuit 530 may generate the L-level base drive differentiation signal DdA in a period of time when the voltage value of the base drive signal aA is regarded to be constant. The differentiating circuit 530 may output the base drive differentiation signal DdA to the demodulation circuit 560.

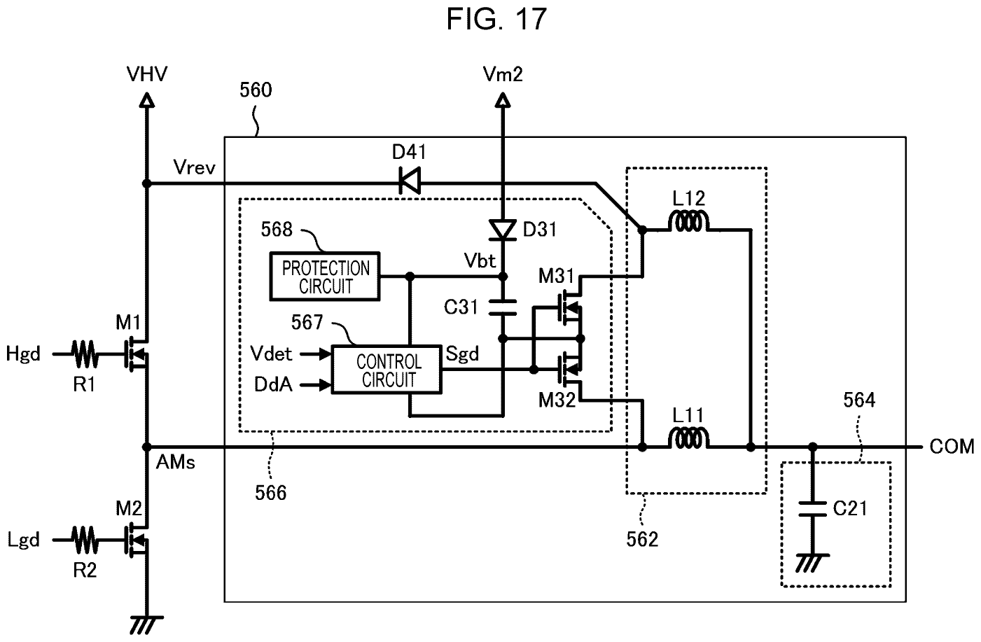

FIG. 17 is a diagram illustrating an example of the configuration of the demodulation circuit 560 according to the second embodiment. As illustrated in FIG. 17, the base drive differentiation signal DdA is input to the control circuit 567 included in the switch circuit 566 of the demodulation circuit 560. The control circuit 567 generates, based on the logic level of the base drive differentiation signal DdA and the voltage value of the drive voltage detection signal Vdet, a gate signal Sgd of which a logic level changes, and outputs the generated gate signal Sgd to the transistors M31 and M32. Specifically, the control circuit 567 sets the logic level of the gate signal Sgd to an H level when the logic level of the base drive differentiation signal DdA is switched from an L level to an H level, and then sets the logic level of the gate signal Sgd to an L level when the voltage value of the drive voltage detection signal Vdet falls below a predetermined threshold.

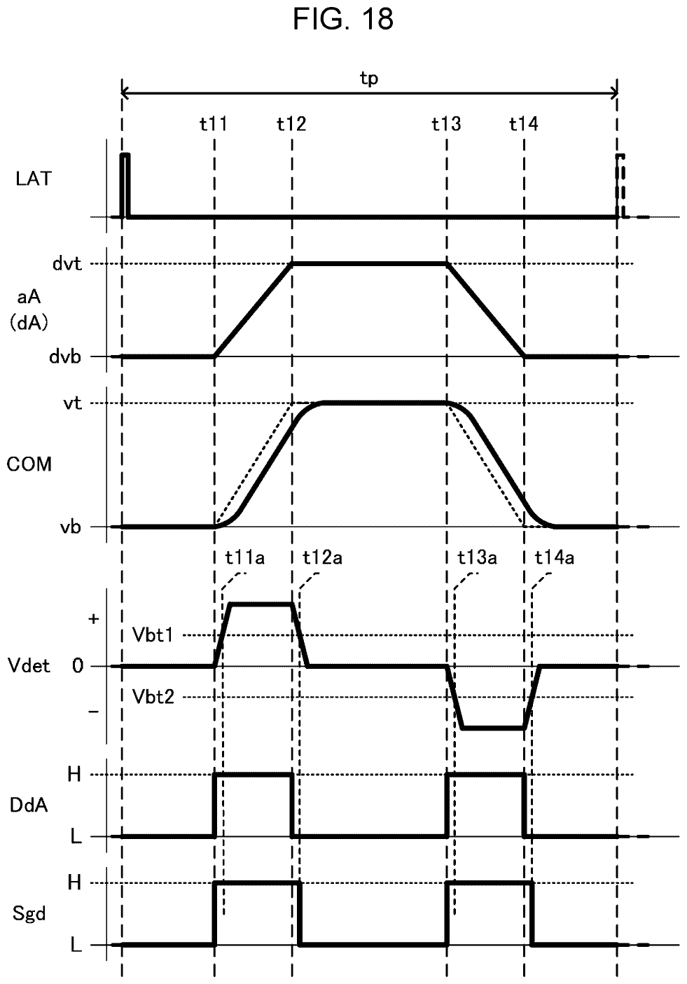

An example of the operation of the demodulation circuit 560 configured as described above in the second embodiment will be described. FIG. 18 is a diagram for explaining an example of the operation of the demodulation circuit 560 according to the second embodiment. As illustrated in FIG. 18, at a rising edge of the latch signal LAT, the voltage value of the base drive signal aA is constant at the voltage dvb, and thus the differentiating circuit 530 outputs the L-level base drive differentiation signal DdA, and the drive signal output circuit 51 operates such that the voltage value of the output drive signal COM is constant at the voltage vb. In this case, since the voltage value of the drive signal COM is controlled to be constant at the voltage vb, the differentiating circuit 580 outputs the drive voltage detection signal Vdet in which the average value of voltage values is substantially zero. Therefore, the control circuit 567 outputs the L-level gate signal Sgd, and the transistors M31 and M32 are controlled to be non-conductive. Therefore, the inductance value of the inductive circuit 562 is set to the inductance value of the inductor L11, and the demodulation circuit 560 outputs the drive signal COM obtained by demodulating the amplified modulated signal AMs by the low-pass filter configured by the inductor L11 and the capacitor C21.

Thereafter, at time t11, the voltage value of the signal waveform, defined by the base drive signal dA, of the base drive signal aA increases from the voltage dvb toward the voltage dvt. That is, at time t11, the value of the base drive signal dA changes. Therefore, the differentiating circuit 530 switches the logic level of the base drive differentiation signal DdA from the L level to the H level. The control circuit 567 switches the logic level of the gate signal Sgd from the L level to the H level when the logic level of the base drive differentiation signal DdA is switched from the L level to the H level. As a result, the transistors M31 and M32 are controlled to be conductive, and the inductance value of the inductive circuit 562 is set to the combined inductance value of the inductors L11 and L12 coupled in parallel. That is, at time t11, the inductance value of the inductive circuit 562 decreases. Then, the demodulation circuit 560 outputs the drive signal COM obtained by demodulating the amplified modulated signal AMs by the low-pass filter constituted by the inductors L11 and L12 coupled in parallel and the capacitor C21.

Further, at time t11, the voltage value of the signal waveform, defined by the base drive signal dA, of the base drive signal aA increases from the voltage dvb toward the voltage dvt, and thus the drive signal output circuit 51 operates such that the voltage value of the output drive signal COM increases from the voltage vb toward the voltage vt. At this time, the voltage value of the drive voltage detection signal Vdet output by the differentiating circuit 580 increases due to the change in the voltage value of the drive signal COM, that is, due to the increase in the voltage value of the drive signal COM. Thereafter, at time t11a, the voltage value of the drive voltage detection signal Vdet exceeds the threshold voltage Vbt1. At this time, the control circuit 567 continues to output the H-level gate signal Sgd.

Thereafter, at time t12, the voltage value of the signal waveform, defined by the base drive signal dA, of the base drive signal aA is set to be constant at the voltage dvt. That is, at time t12, the value of the base drive signal dA does not change and is constant. Therefore, the differentiating circuit 530 switches the logic level of the base drive differentiation signal DdA from the H level to the L level. At this time, the control circuit 567 continues to output the H-level gate signal Sgd. Further, at time t12, the voltage value of the signal waveform, defined by the base drive signal dA, of the base drive signal aA is set to be constant at the voltage dvt, and thus the drive signal output circuit 51 operates such that the voltage value of the output drive signal COM is constant at the voltage vt. At this time, since the amount of change in the voltage value of the drive signal COM decreases, the voltage value of the drive voltage detection signal Vdet output by the differentiating circuit 580 decreases toward zero. Thereafter, at time t12a, when the voltage value of the drive voltage detection signal Vdet falls below the threshold voltage Vbt1, the control circuit 567 switches the logic level of the gate signal Sgd from the H level to the L level. As a result, the transistors M31 and M32 are controlled to be non-conductive, and the inductance value of the inductive circuit 562 is set to the inductance value of the inductor L11. That is, at time t12a, the inductance value of the inductive circuit 562 increases. Then, the demodulation circuit 560 outputs the drive signal COM obtained by demodulating the amplified modulated signal AMs by the low-pass filter constituted by the inductor L11 and the capacitor C21.

Thereafter, at time t13, the voltage value of the signal waveform, defined by the base drive signal dA, of the base drive signal aA decreases from the voltage dvt toward the voltage dvb. That is, at time t13, the value of the base drive signal dA changes. Therefore, the differentiating circuit 530 switches the logic level of the base drive differentiation signal DdA from the L level to the H level. The control circuit 567 switches the logic level of the gate signal Sgd from the L level to the H level when the logic level of the base drive differentiation signal DdA is switched from the L level to the H level. As a result, the transistors M31 and M32 are controlled to be conductive, and the inductance value of the inductive circuit 562 is set to the combined inductance value of the inductors L11 and L12 coupled in parallel. That is, at time t13, the inductance value of the inductive circuit 562 decreases. Then, the demodulation circuit 560 outputs the drive signal COM obtained by demodulating the amplified modulated signal AMs by the low-pass filter constituted by the inductors L11 and L12 coupled in parallel and the capacitor C21.

Further, at time t13, the voltage value of the signal waveform, defined by the base drive signal dA, of the base drive signal aA decreases from the voltage dvt toward the voltage dvb, and thus the drive signal output circuit 51 operates such that the voltage value of the output drive signal COM decreases from the voltage vt toward the voltage vb. At this time, the voltage value of the drive voltage detection signal Vdet output by the differentiating circuit 580 decreases due to the change in the voltage value of the drive signal COM, that is, due to the decrease in the voltage value of the drive signal COM. Thereafter, at time t13a, the voltage value of the drive voltage detection signal Vdet falls below the threshold voltage Vbt2. At this time, the control circuit 567 continues to output the H-level gate signal Sgd.

Thereafter, at time t14, the voltage value of the signal waveform, defined by the base drive signal dA, of the base drive signal aA is set to be constant at the voltage dvb. That is, at time t14, the value of the base drive signal dA does not change and is constant. Therefore, the differentiating circuit 530 switches the logic level of the base drive differentiation signal DdA from the H level to the L level. At this time, the control circuit 567 continues to output the H-level gate signal Sgd. Further, at time t14, the voltage value of the signal waveform, defined by the base drive signal dA, of the base drive signal aA is set to be constant at the voltage dvb, and thus the drive signal output circuit 51 operates such that the voltage value of the output drive signal COM is constant at the voltage vb. At this time, since the amount of change in the voltage value of the drive signal COM decreases, the voltage value of the drive voltage detection signal Vdet output by the differentiating circuit 580 increases toward zero. Thereafter, at time t14a, when the voltage value of the drive voltage detection signal Vdet exceeds the threshold voltage Vbt2, the control circuit 567 switches the logic level of the gate signal Sgd from the H level to the L level. As a result, the transistors M31 and M32 are controlled to be non-conductive, and the inductance value of the inductive circuit 562 is set to the inductance value of the inductor L11. That is, at time t14a, the inductance value of the inductive circuit 562 increases. Then, the demodulation circuit 560 outputs the drive signal COM obtained by demodulating the amplified modulated signal AMs by the low-pass filter constituted by the inductor L11 and the capacitor C21. Then, at the next rising edge of the latch signal LAT, the period tp ends.

As described above, in the liquid ejecting apparatus 1 and the drive signal output circuit 51 according to the second embodiment, the control circuit 567 determines, based on a change in the value of the base drive signal dA from a constant value to a changing value, that the current period is a period of time when the voltage value of the drive signal COM changes. That is, the control circuit 567 determines, based on a change in the value of the base drive signal dA from a constant value to a changing value, that the current period is a period of time when the voltage value of the drive signal COM changes from the voltage vb toward the voltage vt and that the current period is a period of time when the voltage value of the drive signal COM changes from the voltage vt toward the voltage vb, and outputs the H-level gate signal Sgd for controlling the transistors M31 and M32 to be conductive. In the liquid ejecting apparatus 1 and the drive signal output circuit 51 according to the second embodiment, the control circuit 567 determines, based on a change in the value of the base drive signal dA from a changing value to a constant value, that the current period is a period of time when the voltage value of the drive signal COM is controlled to be constant at the voltage vb or the voltage vt, and outputs the L-level gate signal Sgd for controlling the transistors M31 and M32 to be non-conductive.

As illustrated in FIG. 18, the change in the voltage value of the drive signal COM is delayed with respect to the change in the voltage value of the signal waveform defined by the base drive signal dA, that is, with respect to the change in the voltage value of the signal waveform of the base drive signal aA. In the liquid ejecting apparatus 1 and the drive signal output circuit 51 according to the second embodiment, the control circuit 567 determines, based on a change in the value of the base drive signal dA from a constant value to a changing value, that the current period is a period of time when the voltage value of the drive signal COM changes. That is, the control circuit 567 determines, based on a change in the value of the base drive signal dA from a constant value to a changing value, that the current period is a period of time when the voltage value of the drive signal COM changes from the voltage vb toward the voltage vt and that the current period is a period of time when the voltage value of the drive signal COM changes from the voltage vt toward the voltage vb, and outputs the H-level gate signal Sgd for controlling the transistors M31 and M32 to be conductive, whereby it is possible to detect a change in the voltage value of the drive signal COM before a change in the voltage of the signal waveform of the drive signal COM, and to decrease the inductance value of the inductive circuit 562 included in the demodulation circuit 560. As a result, the amount of delay of the change in the voltage value of the drive signal COM with respect to the change in the voltage value of the signal waveform of the base drive signal aA, that is, with respect to the change in the voltage value of the signal waveform defined by the base drive signal dA, is decreased, and it is possible to achieve a higher frequency of the drive signal COM.

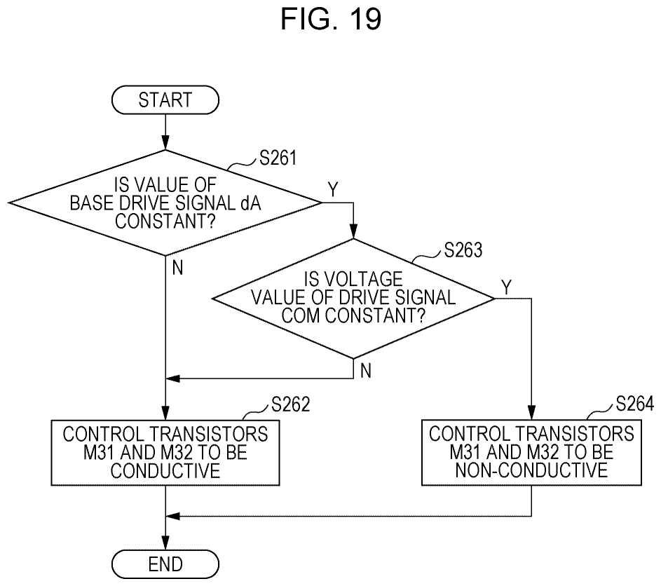

Next, a method of controlling the liquid ejecting apparatus 1 including the drive signal output circuit 51 according to the second embodiment will be described. In the method of controlling the liquid ejecting apparatus 1 having the drive signal output circuit 51 according to the second embodiment, a method for a demodulation process is different from that in the method of controlling the liquid ejecting apparatus 1 according to the first embodiment. FIG. 19 is a diagram illustrating a specific example of the demodulation process according to the second embodiment. As illustrated in FIG. 19, in the demodulation process according to the second embodiment, the control circuit 567 included in the switch circuit 566 determines, based on the input base drive differentiation signal DdA, whether the value of the base drive signal dA is constant (step S261). Specifically, the control circuit 567 determines that the value of the base drive signal dA is constant when the logic level of the input base drive differentiation signal DdA is the L level, and determines that the value of the base drive signal dA is not constant when the logic level of the input base drive differentiation signal DdA is the H level.

Then, if the control circuit 567 determines that the value of the base drive signal dA is not constant (N in step S261), that is, if the control circuit 567 determines that the value of the base drive signal dA changes, the control circuit 567 outputs the H-level gate signal Sgd. Accordingly, the transistors M31 and M32 are controlled to be conductive (step S262). Therefore, the inductance value of the inductive circuit 562 included in the demodulation circuit 560 is controlled to the combined inductance value of the inductors L11 and L12 coupled in parallel.

On the other hand, if the control circuit 567 determines that the value of the base drive signal dA is constant (Y in step S261), the control circuit 567 determines, based on the drive voltage detection signal Vdet, whether the voltage value of the drive signal COM is constant (step S263). Then, if the control circuit 567 determines that the voltage value of the drive signal COM is not constant (N in step S263), that is, if the control circuit 567 determines that the voltage value of the drive signal COM changes, the control circuit 567 outputs the H-level gate signal Sgd. Accordingly, the transistors M31 and M32 are controlled to be conductive (step S262). Therefore, the inductance value of the inductive circuit 562 included in the demodulation circuit 560 is controlled to the combined inductance value of the inductors L11 and L12 coupled in parallel.

On the other hand, if the control circuit 567 determines that the voltage value of the drive signal COM is constant (Y in step S263), the control circuit 567 outputs the L-level gate signal Sgd. Accordingly, the transistors M31 and M32 are controlled to be non-conductive (step S264). Therefore, the inductance value of the inductive circuit 562 included in the demodulation circuit 560 is controlled to the inductance value of the inductor L11.

That is, in the method of controlling the liquid ejecting apparatus 1 according to the second embodiment, in the demodulation process, the control circuit 567 determines, based on information indicating differentiation of the base drive signal dA, whether the voltage value of the drive signal COM based on the base drive signal dA, that is, the voltage value of the signal waveform defined by the base drive signal dA changes or does not change. Then, the control circuit 567 determines, based on a change in the value of the base drive signal dA from a constant value to a changing value, that the current period is a period of time when the voltage value of the drive signal COM changes. That is, the control circuit 567 determines, based on a change in the value of the base drive signal dA from a constant value to a changing value, that the current period is a period of time when the voltage value of the drive signal COM changes the from the voltage vb toward the voltage vt and that the current period is a period of time when the voltage value of the drive signal COM changes from the voltage vt toward the voltage vb, and outputs the H-level gate signal Sgd for controlling the transistors M31 and M32 to be conductive. The control circuit 567 determines, based on a change in the value of the base drive signal dA from a changing value to a constant value, that the current period is a period of time when the voltage value of the drive signal COM does not change and is constant the voltage vb or the voltage vt, and outputs the L-level gate signal Sgd for controlling the transistors M31 and M32 to be non-conductive.

In the method of controlling the liquid ejecting apparatus 1 according to the second embodiment as described above, the control circuit 567 determines, based on a change in the value of the base drive signal dA from a constant value to a changing value, that the current period is a period of time when the voltage value of the drive signal COM changes. That is, the control circuit 567 determines, based on a change in the value of the base drive signal dA from a constant value to a changing value, that the current period is a period of time when the voltage value of the drive signal COM changes from the voltage value vb to the voltage vt and that the current period is a period of time when the voltage value of the drive signal COM changes from the voltage value vt to the voltage vb, and outputs the H-level gate signal Sgd for controlling the transistors M31 and M32 to be conductive, whereby it is possible to detect a change in the voltage value of the drive signal COM before a change in the voltage of the signal waveform of the drive signal COM, and to decrease the inductance value of the inductive circuit 562 included in the demodulation circuit 560. As a result, the amount of delay of the change in the voltage value of the drive signal COM with respect to the change in the voltage value of the signal waveform of the base drive signal aA, that is, with respect to the change in the voltage value of the signal waveform defined by the base drive signal dA, is decreased, and it is possible to further increase the frequency of the drive signal COM.

Step S262 illustrated in FIG. 19 corresponds to step S252 illustrated in FIG. 13, step S263 illustrated in FIG. 19 corresponds to step S251 illustrated in FIG. 13, and step S264 illustrated in FIG. 19 corresponds to step S253 illustrated in FIG. 13.

### 3. Third Embodiment

Next, a liquid ejecting apparatus 1 and a drive signal output circuit 51 according to a third embodiment will be described. In the liquid ejecting apparatus 1 according to the third embodiment, the switch circuit 566 included in the demodulation circuit 560 switches the inductance value of the inductive circuit 562 based on an amount of change in the voltage value of the signal waveform, defined by the base drive signal dA, of the base drive signal aA per predetermined time and the number of piezoelectric elements 60 to be driven by drive signals VOUT based on the drive signal COM in addition to the result of determining, based on the drive voltage detection signal Vdet output by the differentiating circuit 580, whether the voltage value of the drive signal COM is constant. This feature is different from the liquid ejecting apparatuses 1 according to the first embodiment and the second embodiment. In the description of the liquid ejecting apparatus 1 and the drive signal output circuit 51 according to the third embodiment, the same components as those of the liquid ejecting apparatuses 1 and the drive signal output circuits 51 according to the first embodiment and the second embodiment are denoted by the same reference signs, and the description thereof will be omitted or simplified.

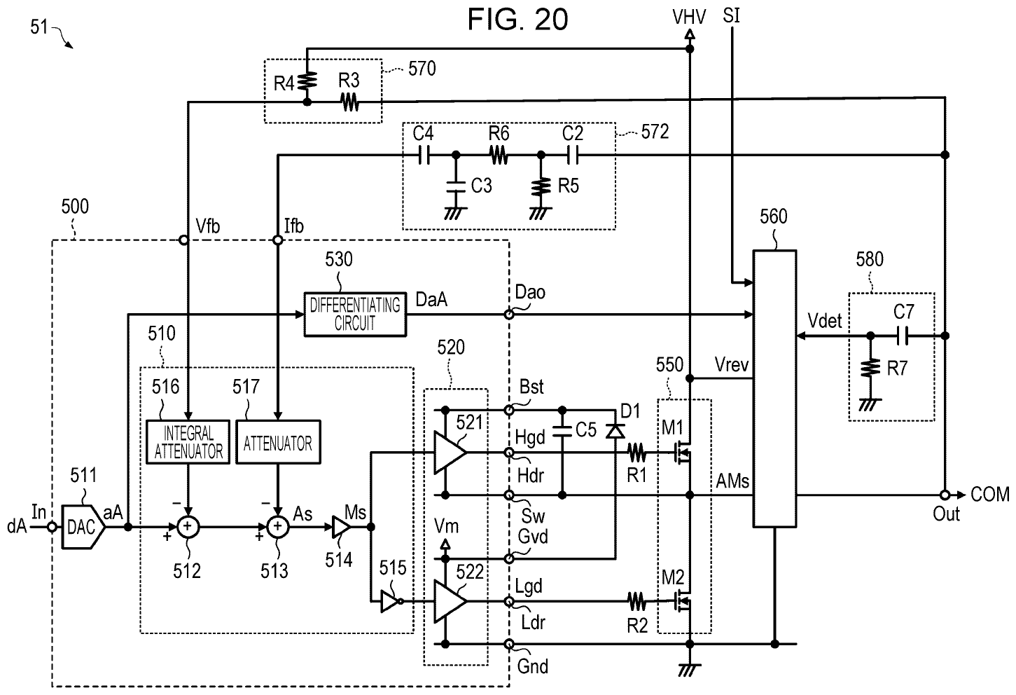

FIG. 20 is a diagram illustrating a configuration of the drive signal output circuit 51 according to the third embodiment. As illustrated in FIG. 20, the drive signal output circuit 51 according to the third embodiment includes a differentiating circuit 531. The base drive signal aA is input to the differentiating circuit 531. The differentiating circuit 531 generates a base drive differentiation signal DaA by differentiating the signal waveform of the input base drive signal aA, and outputs the generated base drive differentiation signal DaA to the demodulation circuit 560. In addition, as illustrated in FIG. 20, the print data signal SI output by the control circuit 100 is also input to the demodulation circuit 560 included in the drive signal output circuit 51 according to the third embodiment.

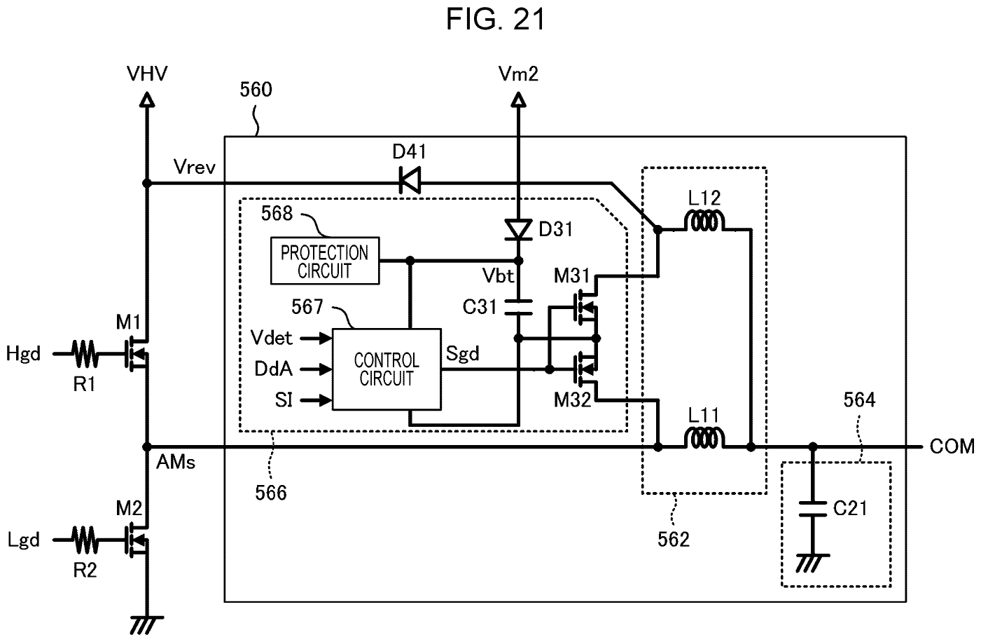

FIG. 21 is a diagram illustrating an example of the configuration of the demodulation circuit 560 according to the third embodiment. As illustrated in FIG. 21, the base drive differentiation signal DaA and the print data signal SI are input to the control circuit 567 included in the switch circuit 566 of the demodulation circuit 560. Then, the control circuit 567 switches the inductance value of the inductive circuit 562 included in the demodulation circuit 560 by outputting the gate signal Sgd of which the logic level is switched based on the drive voltage detection signal Vdet output by the differentiating circuit 580, the base drive differentiation signal DaA, and the print data signal SI.

Specifically, the control circuit 567 determines whether the voltage value of the input base drive differentiation signal DaA is greater than or equal to a predetermined threshold. The base drive differentiation signal DaA output by the differentiating circuit 531 is obtained by differentiating the signal waveform of the base drive signal aA, and the voltage value of the base drive differentiation signal DaA is proportional to the amount of change in the voltage value of the signal waveform of the base drive signal aA per predetermined time. That is, when the voltage value of the signal waveform of the base drive signal aA sharply changes, the voltage value of the base drive differentiation signal DaA that is the differential value of the signal waveform of the base drive signal aA increases. When the voltage value of the signal waveform of the base drive signal aA gradually changes, the voltage value of the base drive differentiation signal DaA that is the differential value of the signal waveform of the base drive signal aA decreases. The control circuit 567 determines whether the voltage value of the base drive differentiation signal DaA is greater than or equal to the predetermined threshold, thereby determining whether the amount of change in the voltage value of the signal waveform, defined by the base drive signal dA, of the base drive signal aA per predetermined time, that is, the amount of change in the voltage value of the drive signal COM per predetermined time is greater than a predetermined threshold.

In addition, the control circuit 567 calculates, based on the input print data signal SI, the number of piezoelectric elements 60 to which drive signals VOUT based on the drive signal COM are supplied. As described above, the print data signal SI serially includes the 1-bit print data pieces [SId] for selecting whether to eject ink. The 1-bit print data pieces [SId] correspond to the respective m ejection sections 600. The print data pieces [SId] included in the print data signal SI are [1] when the ink is to be ejected from the ejection sections 600 and the drive signals VOUT based on the drive signal COM are to be supplied to the piezoelectric elements 60 included in the ejection sections 600. The print data pieces [SId] included in the print data signal SI are [0] when the ink is not to be ejected from the ejection sections 600 and the drive signals VOUT based on the drive signal COM are not to be supplied to the piezoelectric elements 60 included in the ejection sections 600. The control circuit 567 counts, based on the input print data signal SI, the number of print data pieces [SId] indicating [1] or the number of print data pieces [SId] indicating [0] among the m 1-bit print data pieces [SId] corresponding to the m ejection sections 600, and calculates the number of piezoelectric elements 60 to which drive signals VOUT based on the drive signal COM are supplied.

The m piezoelectric elements 60 included in the m ejection sections 600 are coupled in parallel, via the selection circuits 230, to a propagation path for the drive signal COM output by the drive signal output circuit 51. Therefore, the number of piezoelectric elements 60 to which drive signals VOUT based on the drive signal COM are supplied is proportional to a load capacitance coupled to the propagation path for the drive signal COM. That is, the control circuit 567 calculates the load capacitance coupled to the propagation path for the drive signal COM by calculating, based on the input print data signal SI, the number of piezoelectric elements 60 to which drive signals VOUT based on the drive signal COM are supplied.

Then, the control circuit 567 switches the inductance value of the inductive circuit 562 included in the demodulation circuit 560 by outputting the gate signal Sgd of which the logic level is switched based on the result of determining, based on the drive voltage detection signal Vdet output by the differentiating circuit 580, whether the voltage value of the drive signal COM is constant, the result of determining, based on the base drive differentiation signal DaA, whether the amount of change in the voltage value of the drive signal COM per predetermined time is greater than the predetermined threshold, and the result of calculating, based on the print data signal SI, the load capacitance coupled to the propagation path for the drive signal COM. In other words, the switch circuit 566 switches the inductance value of the inductive circuit 562 between the inductance value of the inductor L11 and the combined inductance value of the inductors L11 and 112 coupled in parallel, based on the amount of change in the voltage value of the signal waveform, defined by the base drive signal dA, of the base drive signal aA per predetermined time, and the load capacitance coupled to the propagation path through which the drive signal COM propagates, in addition to the result of determining whether the voltage value of the drive signal COM is constant.

When the amount of change in the voltage value of the signal waveform, defined by the base drive signal dA, of the base drive signal aA per predetermined time is small, and the load capacitance coupled to the propagation path of the drive signal COM is small, the value of the current flowing through the inductive circuit 562 is small. In the liquid ejecting apparatus 1 and the drive signal output circuit 51 according to the third embodiment, the switch circuit 566 switches the inductance value of the inductive circuit 562 between the inductance value of the inductor L11 and the combined inductance value of the inductors L11 and L12 coupled in parallel, based on the amount of change in the voltage value of the signal waveform, defined by the base drive signal dA, of the base drive signal aA per predetermined time, and the load capacitance coupled to the propagation path through which the drive signal COM propagates, in addition to the result of determining whether the voltage value of the drive signal COM is constant. Thus, even in a period of time when the voltage value of the drive signal COM changes, when the value of the current flowing through the inductive circuit 562 is small, the inductance value of the inductive circuit 562 can be switched to the inductance value of the inductor L11. Thus, in a period of time when the voltage value of the drive signal COM changes, the possibility that a ripple voltage may be superimposed on the signal waveform of the drive signal COM is reduced, and the accuracy of the signal waveform of the output drive signal COM is improved.

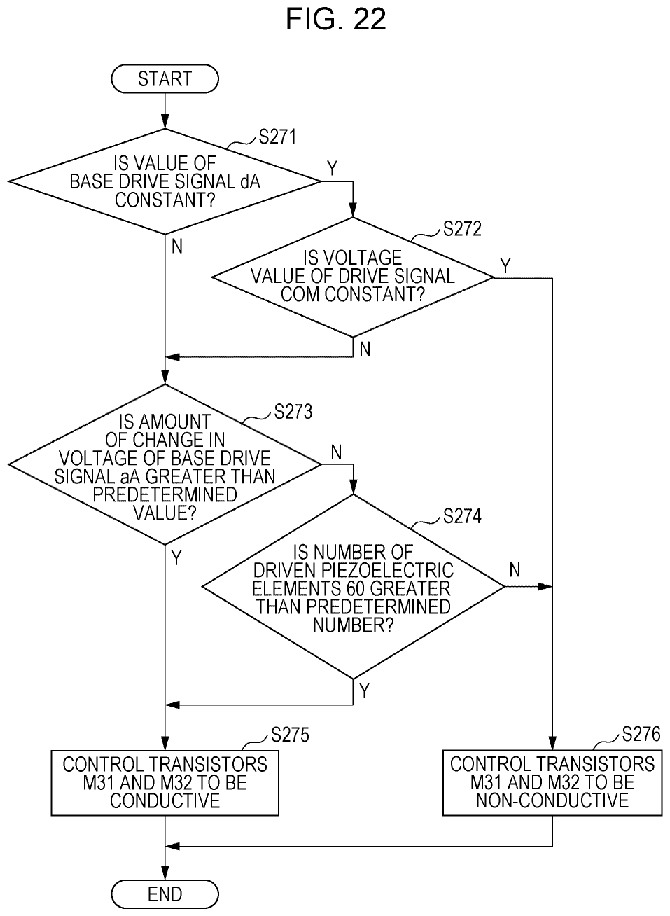

Next, a method of controlling the liquid ejecting apparatus 1 including the drive signal output circuit 51 according to the third embodiment will be described. In the method of controlling the liquid ejecting apparatus 1 including the drive signal output circuit 51 according to the third embodiment, a method for a demodulation process is different from those in the methods of controlling the liquid ejecting apparatuses 1 according to the first embodiment and the second embodiment. FIG. 22 is a diagram illustrating a specific example of the demodulation process according to the third embodiment. As illustrated in FIG. 22, in the demodulation process according to the third embodiment, the control circuit 567 included in the switch circuit 566 determines, based on the input base drive differentiation signal DaA, whether the value of the base drive signal dA is constant (step S271). Specifically, the voltage value of the base drive differentiation signal DaA is substantially zero in a period of time when the voltage value of the base drive signal aA is constant, and is a voltage value corresponding to the amount of change per predetermined time in a period of time when the voltage value of the base drive signal aA changes. The control circuit 567 determines whether the voltage value of the base drive signal aA is constant and whether the value of the base drive signal dA is constant, based on whether the voltage value of the input base drive differentiation signal DaA is substantially zero.

If the control circuit 567 determines that the value of the base drive signal dA is constant (Y in step S271), that is, if the control circuit 567 determines that the value of the base drive signal dA does not change, the control circuit 567 determines, based on the drive voltage detection signal Vdet, whether the voltage value of the drive signal COM is constant (step S272).

If the control circuit 567 determines that the value of the base drive signal dA is not constant (N in step S271), or if the control circuit 567 determines that the voltage value of the drive signal COM is not constant (N in step S272), the control circuit 567 determines, based on the voltage value of the base drive differentiation signal DaA, whether the amount of change in the base drive signal aA per predetermined time is greater than a predetermined value (step S273). If the control circuit 567 determines that the amount of change in the base drive signal aA per predetermined time is less than or equal to the predetermined value (N in step S273), the control circuit 567 determines, based on the print data signal SI, whether the number of piezoelectric elements 60 that are the load capacitance coupled to the propagation path for the drive signal COM and are to be driven by the drive signal COM is greater than a predetermined number (step S274).

Then, if the control circuit 567 determines that the amount of change in the base drive signal aA per predetermined time is greater than the predetermined value (Y in step S273), or if the control circuit 567 determines that the number of piezoelectric elements 60 to be driven by the drive signal COM is greater than the predetermined number (Y in step S274), the control circuit 567 outputs the H-level gate signal Sgd. Accordingly, the transistors M31 and M32 are controlled to be conductive (step S275). Therefore, the inductance value of the inductive circuit 562 included in the demodulation circuit 560 is controlled to the combined inductance value of the inductor L11 and the inductor L12 that are coupled in parallel.

On the other hand, if the control circuit 567 determines that the voltage value of the drive signal COM is constant (Y in step S272), or if the control circuit 567 determines that the number of piezoelectric elements 60 to be driven by the drive signal COM is less than or equal to the predetermined number (N in step S274), the control circuit 567 outputs the L-level gate signal Sgd. Accordingly, the transistors M31 and M32 are controlled to be non-conductive (step S276). Therefore, the inductance value of the inductive circuit 562 included in the demodulation circuit 560 is controlled to the inductance value of the inductor L11.

As described above, in the method of controlling the liquid ejecting apparatus 1 according to the third embodiment, in periods of time when the voltage value of the drive signal COM changes, that is, in a period of time when the voltage value of the drive signal COM changes from the voltage vb toward the voltage vt and a period of time when the voltage value of the drive signal COM changes from the voltage vt toward the voltage vb, when the amount of change in the voltage value of the base drive signal aA per unit time is less than or equal to the predetermined threshold, and the amount of change in the voltage value of the drive signal COM per unit time is less than or equal to the predetermined threshold, the inductive circuit 562 having the inductance value of the inductor L11 demodulates the amplified modulated signal AMs. In the method of controlling the liquid ejecting apparatus 1 according to the third embodiment, in periods of time when the voltage value of the drive signal COM changes, that is, in a period of time when the voltage value of the drive signal COM changes from the voltage vb toward the voltage vt and a period of time when the voltage value of the drive signal COM changes from the voltage vt toward the voltage vb, when the number of piezoelectric elements 60 to be driven by the drive signal COM is less than or equal to the predetermined threshold number, the inductive circuit 562 having the inductance value of the inductor L11 demodulates the amplified modulated signal AMs.

As described above, when the amount of change in the voltage value of the signal waveform, defined by the base drive signal dA, of the base drive signal aA per predetermined time is small, and the load capacitance coupled to the propagation path for the drive signal COM is small, the value of the current flowing through the inductive circuit 562 is small. In the method of controlling the liquid ejecting apparatus 1 according to the third embodiment, even in a period of time when the voltage value of the drive signal COM changes, when the value of the current flowing through the inductive circuit 562 is small, the amount of change in the voltage value of the signal waveform of the base drive signal aA per predetermined time is small, and the load capacitance coupled to the propagation path for the drive signal COM is small, the inductance value of the inductive circuit 562 is set to the inductance value of the inductor L11. Therefore, in a period of time when the voltage value of the drive signal COM changes, the possibility that a ripple voltage may be superimposed on the signal waveform of the drive signal COM is reduced, and the accuracy of the signal waveform of the output drive signal COM is improved.

In the method of controlling the liquid ejecting apparatus 1 including the drive signal output circuit 51 according to the third embodiment, when the amount of change in the voltage value of the signal waveform defined by the base drive signal dA per predetermined time, that is, the amount of change in the voltage value of the signal waveform of the base drive signal aA per predetermined time is small, and the load capacitance coupled to the propagation path for the drive signal COM is small, the inductance value of the inductive circuit 562 is set to the inductance value of the inductor L11. However, in the demodulation process, only one of the determination as to whether the amount of change in the voltage value of the signal waveform, defined by the base drive signal dA, of the base drive signal aA per predetermined time is small and the determination as to whether the load capacitance coupled to the propagation path for the drive signal COM is small may be performed.

Further, step S271 illustrated in FIG. 22 corresponds to step S261 illustrated in FIG. 19, step S272 illustrated in FIG. 22 corresponds to step S251 illustrated in FIG. 13 and step S263 illustrated in FIG. 19, step S275 illustrated in FIG. 22 corresponds to step S252 illustrated in FIG. 13 and step S262 illustrated in FIG. 19, and step S276 illustrated in FIG. 22 corresponds to step S253 illustrated in FIG. 13 and step S264 illustrated in FIG. 19.

Although the embodiments and modifications have been described above, the present disclosure is not limited to these embodiments, and can be implemented in various modes without departing from the scope of the present disclosure. For example, the above-described embodiments may be appropriately combined.

The present disclosure includes substantially the same configurations (for example, a configuration having the same functions, methods, and results as those described in the embodiments, or a configuration having the same purposes and effects as those described in the embodiments) as the configurations described in the embodiments. Further, the present disclosure includes configurations in which non-essential sections of the configurations described in the embodiments are replaced. In addition, the present disclosure includes configurations that obtain the same operational effects as those of the configurations described in the embodiments or configurations that can achieve the same purposes as those of the configurations described in the embodiments. Further, the present disclosure includes configurations in which a known technology is added to the configurations described in the embodiments.

The following contents are derived from the above-described embodiments.

In an aspect, a drive signal output circuit that outputs a drive signal for driving a capacitive load includes: a modulation circuit that modulates a base drive signal on which the drive signal is based, and outputs the modulated drive signal as a modulated signal; an amplifier circuit that amplifies the modulated signal and outputs the amplified modulated signal; and a demodulation circuit that demodulates the amplified modulated signal and outputs the demodulated signal as the drive signal. The demodulation circuit includes an inductive circuit, a capacitive circuit, and a switch circuit. The amplified modulated signal is input to a first end of the inductive circuit. A second end of the inductive circuit is electrically coupled to a first end of the capacitive circuit. The demodulation circuit outputs the drive signal from a coupling point where the second end of the inductive circuit and the first end of the capacitive circuit are electrically coupled. The switch circuit switches an inductance value of the inductive circuit between a first inductance value and a second inductance value different from the first inductance value.

In this drive signal output circuit, in a period of time that is until a current flowing through the inductive circuit reaches a predetermined current value and is desired to be shortened, the switch circuit switches the inductance value of the inductive circuit to a smaller value out of the first inductance value and the second inductance value to achieve a high frequency of the drive signal, and in a period of time when a ripple voltage superimposed on the signal waveform of the drive signal may be noticeable, the switch circuit switches the inductance value of the inductive circuit to a larger value out of the first inductance value and the second inductance value to decrease the amplitude of the ripple voltage superimposed on the signal waveform of the drive signal and reduce the possibility that the signal waveform of the drive signal may degrade. Further, in this case, since the capacitance value of the capacitive circuit is constant, the possibility that power consumption in the drive signal output circuit may increase is also reduced.

In an aspect, in the drive signal output circuit, the inductive circuit may include a first inductor element and a second inductor element, the capacitive circuit may include a capacitor element, the amplified modulated signal may be input to a first end of the first inductor element, a second end of the first inductor element may be electrically coupled to a first end of the capacitor element, a first end of the second inductor element may be electrically coupled to a first end of the switch circuit, a second end of the second inductor element may be electrically coupled to the first end of the capacitor element, a second end of the switch circuit may be electrically coupled to the first end of the first inductor element, and the demodulation circuit may output the drive signal from a coupling point where the second end of the first inductor element, the second end of the second inductor element, and the first end of the capacitor element are electrically coupled.

In this drive signal output circuit, in a period of time that is until a current flowing through the inductive circuit reaches a predetermined current value and is desired to be shortened, the switch circuit switches the inductance value of the inductive circuit to a combined inductance value of the first inductor element and the second inductor element coupled in parallel to achieve a high frequency of the drive signal, and in a period of time when a ripple voltage superimposed on a signal waveform of the drive signal may be noticeable, the switch circuit switches the inductance value of the inductive circuit to the inductance value of the first inductor element as the inductance value of the inductive circuit to decrease the amplitude of the ripple voltage superimposed on the signal waveform of the drive signal and reduce the possibility that the signal waveform of the drive signal may degrade. Further, in this case, since the capacitance value of the capacitor element included in the capacitive circuit is constant, it is also possible to reduce the possibility that power consumption in the drive signal output circuit may increase.

In an aspect, in the drive signal output circuit, the inductive circuit may include a first inductor element and a second inductor element, the capacitive circuit may include a capacitor element, the amplified modulated signal may be input to a first end of the first inductor element, a second end of the first inductor element may be electrically coupled to a first end of the second inductor element, a second end of the second inductor element may be electrically coupled to a first end of the capacitor element, a first end of the switch circuit may be electrically coupled to the first end of the second inductor element, a second end of the switch circuit may be electrically coupled to the second end of the second inductor element, and the demodulation circuit may output the drive signal from a coupling point where the second end of the second inductor element and the first end of the capacitor element are electrically coupled.

In this drive signal output circuit, in a period of time that is until a current flowing through the inductive circuit reaches a predetermined current value and is desired to be shortened, the switch circuit switches the inductance value of the inductive circuit to the inductance value of the first inductor element to achieve a high frequency of the drive signal, and in a period of time when a ripple voltage superimposed on the signal waveform of the drive signal may be noticeable, the switch circuit switches the inductance value of the inductive circuit to a combined inductance value of the first inductor element and the second inductor element coupled in series to decrease the amplitude of the ripple voltage superimposed on the signal waveform of the drive signal and reduce the possibility that the signal waveform of the drive signal may degrade. Further, in this case, since the capacitance value of the capacitor element included in the capacitive circuit is constant, it is also possible to reduce the possibility that power consumption in the drive signal output circuit may increase.

In an aspect, in the drive signal output circuit, the inductive circuit may include a first inductor element and a second inductor element, the capacitive circuit may include a capacitor element, a first end of the first inductor element may be electrically coupled to a first output terminal of the switch circuit, a first end of the second inductor element may be electrically coupled to a second output terminal of the switch circuit, a second end of the first inductor element and a second end of the second inductor element may be electrically coupled to a first end of the capacitor element, the amplified modulated signal may be input to an input terminal of the switch circuit, the switch circuit may switch whether to electrically couple the input terminal to the first output terminal or electrically couple the input terminal to the second output terminal, and the demodulation circuit may output the drive signal from a coupling point where the second end of the first inductor element, the second end of the second inductor element, and the first end of the capacitor element are electrically coupled.

In this drive signal output circuit, in a period of time that is until a current flowing through the inductive circuit reaches a predetermined current value and is desired to be shortened, the switch circuit switches the inductance value of the inductive circuit to a smaller inductance value out of the inductance value of the first inductor element and the inductance value of the second inductor element to achieve a high frequency of the drive signal, and in a period of time when a ripple voltage superimposed on a signal waveform of the drive signal may be noticeable, the switch circuit switches the inductance value of the inductive circuit to a larger inductance value out of the inductance value of the first inductor element and the inductance value of the second inductor element to decrease the amplitude of the ripple voltage superimposed on the signal waveform of the drive signal and reduce the possibility that the signal waveform of the drive signal may degrade. Further, in this case, since the capacitance value of the capacitor element included in the capacitive circuit is constant, it is also possible to reduce the possibility that power consumption in the drive signal output circuit may increase.

In an aspect, in the drive signal output circuit, an inductance value of the first inductor element may be greater than an inductance value of the second inductor element.

In an aspect, in the drive signal output circuit, the amplifier circuit may amplify the modulated signal based on an amplification power supply voltage and output the amplified modulated signal, and the demodulation circuit may include a diode element having an anode terminal electrically coupled to the first end of the second inductor element and the first end of the switch circuit, and a cathode terminal to which the amplification power supply voltage is supplied.

In this drive signal output circuit, it is possible to reduce the effect of an induced electromotive force that has occurred in the demodulation circuit.

In an aspect, in the drive signal output circuit, the amplifier circuit may include a first transistor element and a second transistor element that are coupled in a push-pull manner, and may output the amplified modulated signal by driving the first transistor element and the second transistor element, the switch circuit may include a third transistor element that switches whether to input the amplified modulated signal to the first end of the second inductor element, and on-resistance of the third transistor element may be lower than on-resistance of the first transistor element and on-resistance of the second transistor element.

In this drive signal output circuit, it is possible to further improve the accuracy of the waveform of the drive signal.

In an aspect, in the drive signal output circuit, the switch circuit may include an N-channel first FET and an N-channel second FET, a drain terminal of the first FET may be electrically coupled to the first end of the first inductor element, a drain terminal of the second FET may be electrically coupled to the first end of the second inductor element, a source terminal of the first FET may be electrically coupled to a source terminal of the second FET, and a common gate drive signal may be input to a gate terminal of the first FET and a gate terminal of the second FET.

In this drive signal output circuit, it is possible to improve the stability of the operation of the switch circuit.

In an aspect, the drive signal output circuit may further include a drive voltage detection circuit that outputs a voltage change signal corresponding to a change in a voltage value of the drive signal, and the switch circuit may switch, based on the voltage change signal, the inductance value of the inductive circuit between the first inductance value and the second inductance value.

In an aspect, in the drive signal output circuit, the switch circuit may switch the inductance value of the inductive circuit between the first inductance value and the second inductance value based on a change in a voltage value of a signal waveform defined by the base drive signal and a load capacitance coupled to a propagation path through which the drive signal propagates.

In this drive signal output circuit, it is possible to further improve the accuracy of the waveform of the output drive signal.

According to another aspect of the present disclosure, a liquid ejecting apparatus includes: an ejection section that ejects liquid by driving a capacitive load; and a drive signal output circuit that outputs a drive signal for driving the capacitive load. The drive signal output circuit includes a modulation circuit that modulates a base drive signal on which the drive signal is based, and outputs the modulated base drive signal as a modulated signal, an amplifier circuit that amplifies the modulated signal and outputs the amplified modulated signal, and a demodulation circuit that demodulates the amplified modulated signal and outputs the demodulated signal as the drive signal. The demodulation circuit includes an inductive circuit, a capacitive circuit, and a switch circuit. The amplified modulated signal is input to a first end of the inductive circuit. A second end of the inductive circuit is electrically coupled to a first end of the capacitive circuit. The demodulation circuit outputs the drive signal from a coupling point where the second end of the inductive circuit and the first end of the capacitive circuit are electrically coupled. The switch circuit switches an inductance value of the inductive circuit between a first inductance value and a second inductance value different from the first inductance value.

In this liquid ejecting apparatus, in a period of time that is until a current flowing through the inductive circuit reaches a predetermined current value and is desired to be shortened, the switch circuit switches the inductance value of the inductive circuit to a smaller value to achieve a high frequency of the drive signal, and in a period of time when a ripple voltage superimposed on the signal waveform of the drive signal may be noticeable, the switch circuit switches the inductance value of the inductive circuit to a larger value to decrease the amplitude of the ripple voltage superimposed on the signal waveform of the drive signal and reduce the possibility that the signal waveform of the drive signal may degrade. Further, in this case, since the capacitance value of the capacitive circuit is constant, the possibility that power consumption in the drive signal output circuit may increase is also reduced.

In an aspect, in the liquid ejecting apparatus, the inductive circuit may include a first inductor element and a second inductor element, the capacitive circuit may include a capacitor element, the amplified modulated signal may be input to a first end of the first inductor element, a second end of the first inductor element may be electrically coupled to a first end of the capacitor element, a first end of the second inductor element may be electrically coupled to a first end of the switch circuit, a second end of the second inductor element may be electrically coupled to the first end of the capacitor element, a second end of the switch circuit may be electrically coupled to the first end of the first inductor element, and the demodulation circuit may output the drive signal from a coupling point where the second end of the first inductor element, the second end of the second inductor element, and the first end of the capacitor element are electrically coupled.

In this liquid ejecting apparatus, in a period of time that is until a current flowing through the inductive circuit reaches a predetermined current value and is desired to be shortened, the switch circuit switches the inductance value of the inductive circuit to a combined inductance value of the first inductor element and the second inductor element coupled in parallel to achieve a high frequency of the drive signal, and in a period of time when a ripple voltage superimposed on a signal waveform of the drive signal may be noticeable, the switch circuit switches the inductance value of the inductive circuit to the inductance value of the first inductor element to decrease the amplitude of the ripple voltage superimposed on the signal waveform of the drive signal and reduce the possibility that the signal waveform of the drive signal degrade. Further, in this case, since the capacitance value of the capacitor element included in the capacitive circuit is constant, it is also possible to reduce the possibility that power consumption in the drive signal output circuit may increase.

In an aspect, in the liquid ejecting apparatus, the inductive circuit may include a first inductor element and a second inductor element, the capacitive circuit may include a capacitor element, the amplified modulated signal may be input to a first end of the first inductor element, a second end of the first inductor element may be electrically coupled to a first end of the second inductor element, a second end of the second inductor element may be electrically coupled to a first end of the capacitor element, a first end of the switch circuit may be electrically coupled to the first end of the second inductor element, a second end of the switch circuit may be electrically coupled to the second end of the second inductor element, and the demodulation circuit may output the drive signal from a coupling point where the second end of the second inductor element and the first end of the capacitor element are electrically coupled.

In this liquid ejecting apparatus, in a period of time that is until a current flowing through the inductive circuit reaches a predetermined current value and is desired to be shortened, the switch circuit switches the inductance value of the inductive circuit to the inductance value of the first inductor element to achieve a high frequency of the drive signal, and in a period of time when a ripple voltage superimposed on the signal waveform of the drive signal may be noticeable, the switch circuit switches the inductance value of the inductive circuit to a combined inductance value of the first inductor element and the second inductor element coupled in series to decrease the amplitude of the ripple voltage superimposed on the signal waveform of the drive signal and reduce the possibility that the signal waveform of the drive signal may degrade. Further, in this case, since the capacitance value of the capacitor element included in the capacitive circuit is constant, it is also possible to reduce the possibility that power consumption in the drive signal output circuit may increase.

In an aspect, in the liquid ejecting apparatus, the inductive circuit may include a first inductor element and a second inductor element, the capacitive circuit may include a capacitor element, a first end of the first inductor element may be electrically coupled to a first output terminal of the switch circuit, a first end of the second inductor element may be electrically coupled to a second output terminal of the switch circuit, a second end of the first inductor element and a second end of the second inductor element may be electrically coupled to a first end of the capacitor element, the amplified modulated signal may be input to an input terminal of the switch circuit, the switch circuit may switch whether to electrically couple the input terminal to the first output terminal or electrically couple the input terminal to the second output terminal, and the demodulation circuit may output the drive signal from a coupling point where the second end of the first inductor element, the second end of the second inductor element, and the first end of the capacitor element are electrically coupled.

In this liquid ejecting apparatus, in a period of time that is until a current flowing through the inductive circuit reaches a predetermined current value and is desired to be shortened, the switch circuit switches the inductance value of the inductive circuit to a smaller inductance value out of the inductance value of the first inductor element and the inductance value of the second inductor element to achieve a high frequency of the drive signal, and in a period of time when a ripple voltage superimposed on a signal waveform of the drive signal may be noticeable, the switch circuit switches the inductance value of the inductive circuit to a larger inductance value out of the inductance value of the first inductor element and the inductance value of the second inductor element to decrease the amplitude of the ripple voltage superimposed on the signal waveform of the drive signal and reduce the possibility that the signal waveform of the drive signal may degrade. Further, in this case, since the capacitance value of the capacitor element included in the capacitive circuit is constant, it is also possible to reduce the possibility that power consumption in the drive signal output circuit may increase.

In an aspect, in the liquid ejecting apparatus, an inductance value of the first inductor element may be greater than an inductance value of the second inductor element.

In an aspect, in the liquid ejecting apparatus, the amplifier circuit may amplify the modulated signal based on an amplification power supply voltage and output the amplified modulated signal, and the demodulation circuit may include a diode element having an anode terminal electrically coupled to the first end of the second inductor element and the first end of the switch circuit, and a cathode terminal to which the amplification power supply voltage is supplied.

In this liquid ejecting apparatus, it is possible to reduce the effect of an induced electromotive force that has occurred in the demodulation circuit.

In an aspect, in the liquid ejecting apparatus, the amplifier circuit may include a first transistor element and a second transistor element that are coupled in a push-pull manner, and may output the amplified modulated signal by driving the first transistor element and the second transistor element, the switch circuit may include a third transistor element that switches whether to input the amplified modulated signal to the first end of the second inductor element, and on-resistance of the third transistor element may be lower than on-resistance of the first transistor element and on-resistance of the second transistor element.

In this liquid ejecting apparatus, it is possible to further improve the accuracy of the waveform of the drive signal.

In an aspect, in the liquid ejecting apparatus, the switch circuit may include an N-channel first FET and an N-channel second FET, a drain terminal of the first FET may be electrically coupled to the first end of the first inductor element, a drain terminal of the second FET may be electrically coupled to the first end of the second inductor element, a source terminal of the first FET may be electrically coupled to a source terminal of the second FET, and a common gate drive signal may be input to a gate terminal of the first FET and a gate terminal of the second FET.

In this liquid ejecting apparatus, it is possible to increase the stability of the operation of the switch circuit.

In an aspect, the liquid ejecting apparatus may further include a drive voltage detection circuit that outputs a voltage change signal corresponding to a change in a voltage value of the drive signal, and the switch circuit may switch, based on the voltage change signal, the inductance value of the inductive circuit between the first inductance value and the second inductance value.

In an aspect, in the liquid ejecting apparatus, the switch circuit may switch the inductance value of the inductive circuit between the first inductance value and the second inductance value based on a change in a voltage value of a signal waveform defined by the base drive signal and a load capacitance coupled to a propagation path through which the drive signal propagates.

In this liquid ejecting apparatus, it is possible to further increase the accuracy of the waveform of the output drive signal.

What is claimed is:

1. A drive signal output circuit that outputs a drive signal for driving a capacitive load, the drive signal output circuit comprising;
a modulation circuit that modulates a base drive signal on which the drive signal is based, and outputs the modulated base drive signal as a modulated signal;
an amplifier circuit that amplifies the modulated signal and outputs the amplified modulated signal; and
a demodulation circuit that demodulates the amplified modulated signal and outputs the demodulated signal as the drive signal, wherein
the demodulation circuit includes an inductive circuit, a capacitive circuit, and a switch circuit,
the amplified modulated signal is input to a first end of the inductive circuit,
a second end of the inductive circuit is electrically coupled to a first end of the capacitive circuit,
the demodulation circuit outputs the drive signal from a coupling point where the second end of the inductive circuit and the first end of the capacitive circuit are electrically coupled, and
the switch circuit switches an inductance value of the inductive circuit between a first inductance value and a second inductance value different from the first inductance value.

2. The drive signal output circuit according to claim 1, wherein
the inductive circuit includes a first inductor element and a second inductor element,
the capacitive circuit includes a capacitor element,
the amplified modulated signal is input to a first end of the first inductor element,
a second end of the first inductor element is electrically coupled to a first end of the capacitor element,
a first end of the second inductor element is electrically coupled to a first end of the switch circuit,
a second end of the second inductor element is electrically coupled to the first end of the capacitor element,
a second end of the switch circuit is electrically coupled to the first end of the first inductor element, and
the demodulation circuit outputs the drive signal from a coupling point where the second end of the first inductor element, the second end of the second inductor element, and the first end of the capacitor element are electrically coupled.

3. The drive signal output circuit according to claim 1, wherein
the inductive circuit includes a first inductor element and a second inductor element,
the capacitive circuit includes a capacitor element,
the amplified modulated signal is input to a first end of the first inductor element,
a second end of the first inductor element is electrically coupled to a first end of the second inductor element,
a second end of the second inductor element is electrically coupled to a first end of the capacitor element,
a first end of the switch circuit is electrically coupled to the first end of the second inductor element,
a second end of the switch circuit is electrically coupled to the second end of the second inductor element, and
the demodulation circuit outputs the drive signal from a coupling point where the second end of the second inductor element and the first end of the capacitor element are electrically coupled.

4. The drive signal output circuit according to claim 1, wherein
the inductive circuit includes a first inductor element and a second inductor element,
the capacitive circuit includes a capacitor element,
a first end of the first inductor element is electrically coupled to a first output terminal of the switch circuit,
a first end of the second inductor element is electrically coupled to a second output terminal of the switch circuit,
a second end of the first inductor element and a second end of the second inductor element are electrically coupled to a first end of the capacitor element,
the amplified modulated signal is input to an input terminal of the switch circuit,
the switch circuit switches whether to electrically couple the input terminal to the first output terminal or electrically couple the input terminal to the second output terminal, and
the demodulation circuit outputs the drive signal from a coupling point where the second end of the first inductor element, the second end of the second inductor element, and the first end of the capacitor element are electrically coupled.

5. The drive signal output circuit according to claim 2, wherein
an inductance value of the first inductor element is greater than an inductance value of the second inductor element.

6. The drive signal output circuit according to claim 2, wherein
the amplifier circuit amplifies the modulated signal based on an amplification power supply voltage and outputs the amplified modulated signal, and
the demodulation circuit includes a diode element having an anode terminal electrically coupled to the first end of the second inductor element and the first end of the switch circuit, and a cathode terminal to which the amplification power supply voltage is supplied.

7. The drive signal output circuit according to claim 2, wherein
the amplifier circuit includes a first transistor element and a second transistor element that are coupled in a push-pull manner, and outputs the amplified modulated signal by driving the first transistor element and the second transistor element,
the switch circuit includes a third transistor element that switches whether to input the amplified modulated signal to the first end of the second inductor element, and
on-resistance of the third transistor element is lower than on-resistance of the first transistor element and on-resistance of the second transistor element.

8. The drive signal output circuit according to claim 2, wherein
the switch circuit includes an N-channel first FET and an N-channel second FET,
a drain terminal of the first FET is electrically coupled to the first end of the first inductor element,
a drain terminal of the second FET is electrically coupled to the first end of the second inductor element,
a source terminal of the first FET is electrically coupled to a source terminal of the second FET, and
a common gate drive signal is input to a gate terminal of the first FET and a gate of the second FET.

9. The drive signal output circuit according to claim 1, further comprising
a drive voltage detection circuit that outputs a voltage change signal corresponding to a change in a voltage value of the drive signal, wherein
the switch circuit switches the inductance value of the inductive circuit between the first inductance value and the second inductance value based on the voltage change signal.

10. The drive signal output circuit according to claim 1, wherein
the switch circuit switches the inductance value of the inductive circuit between the first inductance value and the second inductance value based on a change in a voltage value of a signal waveform defined by the base drive signal and a load capacitance coupled to a propagation path through which the drive signal propagates.

11. A liquid ejecting apparatus comprising:
an ejection section that ejects liquid by driving a capacitive load; and
a drive signal output circuit that outputs a drive signal for driving the capacitive load,
the drive signal output circuit includes
a modulation circuit that modulates a base drive signal on which the drive signal is based, and outputs the modulated base drive signal as a modulated signal,
an amplifier circuit that amplifies the modulated signal and outputs the amplified modulated signal, and
a demodulation circuit that demodulates the amplified modulated signal and outputs the demodulated signal as the drive signal,
the demodulation circuit includes an inductive circuit, a capacitive circuit, and a switch circuit,
the amplified modulated signal is input to a first end of the inductive circuit,
a second end of the inductive circuit is electrically coupled to a first end of the capacitive circuit,
the demodulation circuit outputs the drive signal from a coupling point where the second end of the inductive circuit and the first end of the capacitive circuit are electrically coupled, and
the switch circuit switches an inductance value of the inductive circuit between a first inductance value and a second inductance value different from the first inductance value.

12. The liquid ejecting apparatus according to claim 11, wherein
the inductive circuit includes a first inductor element and a second inductor element,
the capacitive circuit includes a capacitor element,
the amplified modulated signal is input to a first end of the first inductor element,
a second end of the first inductor element is electrically coupled to a first end of the capacitor element,
a first end of the second inductor element is electrically coupled to a first end of the switch circuit,
a second end of the second inductor element is electrically coupled to the first end of the capacitor element,
a second end of the switch circuit is electrically coupled to the first end of the first inductor element, and
the demodulation circuit outputs the drive signal from a coupling point where the second end of the first inductor element, the second end of the second inductor element, and the first end of the capacitor element are electrically coupled.

13. The liquid ejecting apparatus according to claim 11, wherein
the inductive circuit includes a first inductor element and a second inductor element,
the capacitive circuit includes a capacitor element,
the amplified modulated signal is input to a first end of the first inductor element,
a second end of the first inductor element is electrically coupled to a first end of the second inductor
a second end of the second inductor element is electrically coupled to a first end of the capacitor element,
a first end of the switch circuit is electrically coupled to the first end of the second inductor element,
a second end of the switch circuit is electrically coupled to the second end of the second inductor element, and
the demodulation circuit outputs the drive signal from a coupling point where the second end of the second inductor element and the first end of the capacitor element are electrically coupled.

14. The liquid ejecting apparatus according to claim 11, wherein
the inductive circuit includes a first inductor element and a second inductor element,
the capacitive circuit includes a capacitor element,
a first end of the first inductor element is electrically coupled to a first output terminal of the switch circuit,
a first end of the second inductor element is electrically coupled to a second output terminal of the switch circuit,
a second end of the first inductor element and a second end of the second inductor element are electrically coupled to a first end of the capacitor element,
the amplified modulated signal is input to an input terminal of the switch circuit,
the switch circuit switches whether to electrically couple the input terminal to the first output terminal or electrically couple the input terminal to the second output terminal, and
the demodulation circuit outputs the drive signal from a coupling point where the second end of the first inductor element, the second end of the second inductor element, and the first end of the capacitor element are electrically coupled.

15. The liquid ejecting apparatus according to claim 12, wherein
an inductance value of the first inductor element is greater than an inductance value of the second inductor element.

16. The liquid ejecting apparatus according to claim 12, wherein
the amplifier circuit amplifies the modulated signal based on an amplification power supply voltage and outputs the amplified modulated signal, and
the demodulation circuit includes a diode element having an anode terminal electrically coupled to the first end of the second inductor element and the first end of the switch circuit, and a cathode terminal to which the amplification power supply voltage is supplied.

17. The liquid ejecting apparatus according to claim 12, wherein
the amplifier circuit includes a first transistor element and a second transistor element that are coupled in a push-pull manner, and outputs the amplified modulated signal by driving the first transistor element and the second transistor element,
the switch circuit includes a third transistor element that switches whether to input the amplified modulated signal to the first end of the second inductor element, and
on-resistance of the third transistor element is lower than on-resistance of the first transistor element and on-resistance of the second transistor element.

18. The liquid ejecting apparatus according to claim 12, wherein
the switch circuit includes an N-channel first FET and an N-channel second FET,
a drain terminal of the first FET is electrically coupled to the first end of the first inductor element,
a drain terminal of the second FET is electrically coupled to the first end of the second inductor element,
a source terminal of the first FET is electrically coupled to a source terminal of the second FET, and
a common gate drive signal is input to a gate terminal of the first FET and a gate terminal of the second FET.

19. The liquid ejecting apparatus according to claim 11, further comprising
a drive voltage detection circuit that outputs a voltage change signal corresponding to a change in a voltage value of the drive signal, and
the switch circuit switches the inductance value of the inductive circuit between the first inductance value and the second inductance value based on the voltage change signal.

20. The liquid ejecting apparatus according to claim 11, wherein
the switch circuit switches the inductance value of the inductive circuit between the first inductance value and the second inductance value based on a change in a voltage value of a signal waveform defined by the base drive signal and a load capacitance coupled to a propagation path through which the drive signal propagates.
